(19) United States
(12) Patent Application Publication
(10) Pub. No.: US 2004/0190974 A1
(43) Pub. Date: Sep. 30, 2004

(54) Separately compartmentalized container for containing, storing and dispensing products

(76) Inventors: Thomas J. Cantone, Oceanside, NY (US); Frederick Caputo, Brooklyn, NY (US)

Correspondence Address: RICHARD E. NOVAK, CHESTNUT HILL PROFESSIONAL CENTER, 157 ENGLE STREET, ENGLEWOOD, NJ, 07631, US

(21) Appl. No.: 10/487,555

(22) PCT Filed: Aug. 21, 2002
(86) PCT No.: PCT/US02/26720

Related U.S. Application Data
(63) Continuation of application No. 29/147,515, filed on Aug. 30, 2001, now Pat. No. D474341.

(51) Int. Cl. B05C 1/00; A47L 1/08

(52) U.S. Cl. 401/25; 401/17

(57) ABSTRACT

Described is a compound hollow container (900) having a multiplicity of compartments (16, 17), e.g., two or three compartments, with the container (900) being capable of containing, storing and dispensing one or more liquids such as nail polish and nail polish remover, and nail polish curing agent, and optionally, fluidized solids such as nail glitter and, further optionally, accessories therefor such as nail polish remover cleaning pads (88). The container (900) is equipped with liquid applicators (52), e.g., vertically disposed long brushes (53), or porous pads for each of the liquids and, optionally, a fluidized solid (300) dispenser for the fluidized solids, e.g., a screen (200) or multiplicity of orifices (201A) which can be opened and closed, located in the upper lid portion (10) of the container (900).

### RELATED PATENT APPLICATIONS

This application is a continuation-in-part of Application for U.S. Design Letters patent Ser. No. 29/147,515 filed on Aug. 30, 2001 entitled: DESIGN FOR SEPARABLY BI-COMPARTMENTALIZED CONTAINER FOR STORING AND UTILIZING CONTAINED FLUIDS the disclosure of which is herein incorporated by reference.

### FIELD OF THE INVENTION

Our invention is directed to a compound hollow container having a multiplicity of compartments, e.g., two or three compartments, with the container having a continuously stable upright configuration and being capable of containing, storing and dispensing one or more liquids such as nail polish and nail polish remover, and nail polish curing agent, and optionally, fluidized solids such as nail glitter and, further optionally, accessories therefor such as nail polish remover cleaning pads. The container is equipped with liquid applicators, e.g., vertically disposed long brushes, or porous pads for each of the liquids and, optionally, a fluidized solid dispenser for the fluidized solids, e.g., a screen or multiplicity of orifices which can be opened and closed, located in the upper lid portion of the container. The container accordingly comprises:

(a) A hollow base member means for storing a readily-utilizable first liquid, e.g., nail polish;

(b) An optional storage member means for storing the accessories, e.g., nail polish remover cleaning pads detachably attached to the base member;

(c) A hollow body member means for storing a second readily utilizable second liquid, e.g., nail polish remover or a readily utilizable fluidized solid, e.g., nail glitter, detachably attached to the base member or the storage member;

(d) A downwardly positioned first applicator means, either (i) externally attached to the base of the body member means or (ii) externally attached to the base of the storage member means, extending downwardly therefrom into the interior of the base member for application of said readily-utilizable first liquid;

(e) A capping means detachably attached to the body means in order to prevent spillage of fluids or fluidized solids and control the dispensing of the fluids and fluidized solids;

(f) Optionally attached to either (i) the upper lid of the capping means and extending vertically downwardly therefrom into the interior of the body means or (ii) the upper orifice rim of the body member means and porously covering in its entirety the upper orifice and extending upwardly into the interior of the capping means, a second applicator means, e.g., an elongated brush or a porous spherical or ellipsoidal pad; with the proviso that the lowermost horizontal dimension of the compound hollow container i.e., the diameter of the base of the base member means, is substantially greater than the uppermost horizontal dimension of the compound hollow container, i.e., the diameter of the upper lid of the capping means. The invention is further characterized in that when the container is in an upright position and in a closed configuration, the combined vertical outer surface of each of the base member means, the optional storage member means, the body member means and the capping member means form a substantially unitary continuous unbroken outer surface. Also described is a process for utilizing the aforementioned article and a kit assembly for constructing same.

### THE INVENTION

Our invention is directed to a compound hollow container having a multiplicity of compartments, said container having a continuously stable upright configuration when place on a substantially horizontal planar solid surface and said container being capable of containing, storing and dispensing one or more readily-utilizable liquids, optionally, fluidized solids and, optionally accessories therefor, said container being equipped with liquid applicators for each of the liquids and, optionally, a fluidized solid dispenser for the fluidized solids, comprising:

(a) A hollow base member means for containing, storing and dispensing a readily-utilizable first liquid, said base member means having an outer liquid-impermeable vertically-disposed surface, a lower horizontally-disposed planar base and an upper horizontally-disposed orifice having an upper orifice rim;

(b) Optional storage member means for containing, storing and dispensing accessories, said storage member means having an outer liquid-impermeable vertically-disposed surface and having an upper section and a lower section, said storage member means being liquid-impermeable, said lower section being detachably and sealably attached to the upper orifice rim of the upper orifice of said base member means;

(c) A hollow body member means for containing, storing and dispensing a second readily utilizable second liquid or a readily utilizable fluidized solid, said body member means having an outer liquid-impermeable and fluidized solid-impermeable vertically-disposed surface and a liquid-impermeable or fluidized solid-impermeable substantially planar horizontally-disposed base and having an upper horizontally-disposed orifice having an upper orifice rim, said body member means being detachably and sealably attached at its base to the upper section of said storage member means or to the upper orifice of said base member means;

(d) Downwardly positioned first applicator means, either (i) externally attached to the base of said body member means or (ii) externally attached to the base of said storage member means, extending downwardly therefrom into the interior of said base member for application of said readily-utilizable first liquid;

(e) Capping means having a vertically-disposed outer liquid-impermeable and fluidized solid-impermeable vertically-disposed surface and an upper horizontally-disposed lid which is either liquid-impermeable, fluidized solid-permeable, fluidized solid-impermeable or fluidized solid-permeabilizable, detachably and sealably attached to the rim of the upper orifice of said body member means;

(f) Optionally attached to either (i) the upper lid of said capping means and extending vertically downwardly therefrom into the interior of said body means or (ii) the upper orifice rim of said body member means and porously covering in its entirety said upper orifice and extending upwardly into the interior of said capping means, second applicator means for application of said readily-utilizable second liquid; further characterized in that (i) when the container is in an upright position and in a closed configuration, the combined vertical outer surface of each of the base member means, the optional storage member means, the body member means and the capping member means form a substantially unitary continuous unbroken outer surface and (ii) the horizontal dimension of the lower horizontally-disposed substantially planar base, DBL is substantially greater than the horizontal dimension of the upper horizontally-disposed lid, DLU.

Preferably the container of our invention is one wherein each of the aforementioned attachments is via two mating, juxtaposed screw fittings and/or via two mating snap-fit fittings. The nature of the mating screw fittings and mating snap-fit fittings useful in the practice of our invention and employed in connection with the base member means, the container member means, the storage member means and capping member means of our invention are well known to those having ordinary skill in the art. Specific mating screw fittings, for example those disclosed in Van Montgomery, U.S. Pat. No. 3,971,487 issued on Jul. 27, 1976, the disclosure of which is herein incorporated by reference are preferred in the practice of our invention.

A more preferred embodiment of our invention is a compound hollow bi-compartmentalized container capable of containing, storing and dispensing readily-utilizable liquids and/or readily-utilizable fluidized solids and equipped with liquid applicators for each of the liquids and fluidized solid dispensers for each of the fluidized solids, consisting essentially of:

(a) A vertically-disposed hollow base member having a hollow vertically-disposed frusto-conical base section having a planar circular liquid-impermeable first solid base of radius R₁ of preferably from about 1 cm up to about 2 cm and having a first circular rim having a length of 2πR₁; extending upwardly from the entire circumference of said first circular rim a substantially vertically-disposed liquid-impermeable solid thin cylindrical wall having a height H₁ preferably of from about 2.5 cm up to about 5.0 cm surrounding a first volume V₁ preferably of from about 20 cc up to about 100 cc terminating at an upper horizontal second circular rim having a radius R₂ preferably of from about 1 cm up to about 2 cm; fixedly fused to the entirety of the said second circular rim and extending upwardly, a vertically-disposed outwardly concave upwardly convergent frusto-hyperbolic section having a height H₂ preferably of from about 0.5 cm up to about 1.5 cm and having a thin liquid-impermeable solid cylindrical wall terminating at an upper horizontal third circular rim fully circumventing a first horizontal aperture having a radius R₃ preferably of from about 0.5 up to about 1.5 cm with the proviso that R₂>R₃; and fixedly fused to said third circular rim a first vertically-disposed cylindrical section having a liquid-impermeable thin solid cylindrical wall and a height H₃preferably of from about 0.5 cm up to about 1.0 cm and an inner first cylinder surface and an outer first cylinder surface, said outer first cylinder surface being horizontally threaded with a first thread pitch ρ and a thread depth Δ, said first cylindrical section fully circumventing the entirety of a second horizontally disposed aperture of radius R₃;

(b) Removably attached to said hollow base member onto said first vertically-disposed cylindrical section, a vertically-disposed hollow body member having a hollow vertically-disposed frusto-conical body section having a horizontally-disposed planar circular liquid-impermeable or fluidized solid-impermeable second solid base of radius R₂′ preferably of from about 1 cm up to about 2 cm having a fourth circular rim circumventing said second solid base; fixedly attached proximate the center of said second solid base, and extending vertically downwardly therefrom into the interior of said frusto-conical base section a first applicator member having a length L₁ preferably of from about 3.0 cm up to about 6.5 cm with the proviso that H₁≦L₁≦[H₁+H₂+H₃]; fixedly fused to the entirety of said fourth circular rim and extending downwardly, a vertically-disposed outwardly concave downwardly convergent frusto-hyperbolic section having a height H₂′ preferably of from about 0.5 cm up to about 1.5 cm and having a thin liquid-impermeable wall terminating at a lower horizontal fifth circular rim circumventing a third horizontally-disposed aperture of radius R₃′ which is co-planar with said second horizontally-disposed aperture, with the proviso that R₃=R₃′; fixedly fused to the entirety of said lower horizontal fifth circular rim, and extending upwardly therefrom, within the confines of said downwardly convergent frusto-hyperbolic section, in a direction perpendicular to the plane of said third horizontally-disposed aperture, a second vertically-disposed cylindrical section having a liquid or fluidized solid-impermeable thin solid wall of height H₃′ preferably of from about 0.5 cm up to about 1 cm and an inner second cylinder surface and an outer second cylinder surface, said inner second cylinder surface being horizontally threaded with a second thread having a thread pitch ρ′ and a thread depth Δ′, said second thread mating with, being juxtaposed and removably sealably cooperating with said first thread of said first cylindrical section of said base member (a); extending upwardly from the entirety of said fourth circular rim a substantially vertically-disposed liquid-impermeable solid thin wall having a height H₁′ preferably of from about 2.5 cm up to about 5.0 cm surrounding a second volume V₂ preferably of from about 20 cc up to about 100 cc terminating at an upper horizontally-disposed sixth circular rim having a radius R₂′ preferably of from about 1 cm up to about 2 cm; fixedly fused to the entirety of said sixth circular rim and extending upwardly therefrom in a direction perpendicular to the plane of said third horizontally-disposed aperture, a third vertically-disposed cylindrical section having a liquid or fluidized solid-impermeable thin solid wall and a height H₄ preferably of from about 0.5 cm up to about 1.0 cm and an inner third cylinder surface and an outer third cylinder surface, said outer third cylinder surface being horizontally threaded with a third thread having a thread pitch ρ″ and a thread depth Δ″, said third cylinder wall terminating at a seventh circular rim circumventing a fourth horizontally-disposed aperture having a radius R₄ preferably of from about 1 cm up to about 2 cm with the proviso that R4≦R₃; and

(c) Removably attached to said hollow body member onto said third vertically disposed cylinder section, a container capping member having a horizontally-disposed liquid or fluidized solid-impermeable solid circular planar base member or porous fluidized solid-permeable circular planar base member having a radius R₅ preferably of from about 0.5 up to about 1.5 cm and circumvented by an eighth circular rim having a circumference of 2πR₅; fixedly fused to, and extending downwardly from the entirety of the circumference of said eighth circular rim, an outwardly, downwardly expanding frusto-conical wall having a height H₅ preferably of from about 2 cm up to about 4 cm, terminating on the inner portion thereof in a fourth cylindrical section having a height H₄′ preferably of from about 0.5 cm up to about 1.0 cm, said fourth cylindrical section having a fourth inner cylindrical surface and a fourth outer cylindrical surface, said fourth inner cylindrical surface being horizontally threaded with a fourth thread having a thread pitch, ρ″′ and a thread depth, Δ″′, said fourth thread mating with, being juxtaposed with, and sealably cooperative with said third thread of said hollow body member; optionally fixedly attached proximate the center of said third solid planar base, and extending vertically downward therefrom into the interior or said frusto-conical body section, in a direction perpendicular to the plane of said third solid planar base, a second applicator member having a length, L₂ preferably of from about 3 cm up to about 8 cm with the proviso that H₁′≦L₂≦[H₁′+H₄+H₅]; further characterized in that when the container is in an upright position and in a closed configuration, the combined vertical outer surface of each of the base member, the body member and the capping member form a substantially unitary continuous unbroken surface.

Our invention is also directed to a process for utilizing the above-described container which process comprises the steps of:

(a) Placing a first utilizable fluid into said base member means;

(b) Placing a second utilizable fluid into said body member means;

(c) Constructing said container by attaching said storage means to said base means and to said body means and then attaching said capping means to the upper rim of said body means;

(d) Storing said container containing said utilizable fluids for a finite period of time;

(e) Detaching said storage means or said body member means from said base member means;

(f) Applying said first utilizable fluid to a first surface removed from said article;

(g) Re-attaching said storage means or said body means to said base means;

(h) Detaching said capping means from said body means;

(i) Applying said second utilizable fluid to said first surface removed from said article; and

(j) Re-attaching said capping means to said body means.

Our invention is also directed to a kit assembly for the construction of a compound hollow container having a multiplicity of compartments, said container having a continuously stable upright configuration when placed on a substantially horizontal planar solid surface, the container being capable of containing, storing and dispensing one or more readily-utilizable liquids, fluidized solids and accessories therefor, said container being equipped with liquid applicators for each of the liquids and a fluidized solid dispenser for the fluidized solids. The kit assembly of our invention comprises:

(a) A container member means holding palate having a multiplicity of indented three-dimensional holding spaces for fixedly and removably holding container member means;

(b) At least one hollow base member means each of which has an upper circumferential rim and each of which stores one readily-utilizable first liquid, each of which base member means is fixedly and removably contained in an indented three-dimensional holding space of said holding palate;

(c) At least one storage member, each of which stores accessories, said storage member being detachably attachable to each of said base member means, each of said storage members being fixedly and removably contained in an indented three-dimensional holding space of said holding palate;

(d) At least one first hollow body member means each of which has an upper circumferential rim and each of which stores one second readily-utilizable second liquid, each of which body member means being fixedly and removably contained in an indented three-dimensional holding space of said holding palate;

(e) At least one second hollow body member means each of which has an upper circumferential rim and each of which stores one readily-utilizable fluidized solid, each of which body member means being fixedly and removably contained in an indented three-dimensional holding space of said holding palate;

(f) At least two downwardly positionable applicator means, at least one of which is externally attachable to the base of a hollow body member means and at least another of which is externally attachable to the base of a storage member means, each applicator means being capable of extending downwardly from its point of attachment into the interior of the base member for application of said readily-utilizable first liquid, each applicator means being fixedly and removably contained in an indented three-dimensional holding space of said holding palate;

(g) At least two capping member means each of which is fixedly and removably contained in an indented three-dimensional holding space of said holding palate, and each of which capping member means is detachably attachable to the upper rim of a body member means, a first capping member means having an solid impermeable upper lid and a second capping member means having a permeabilizable upper lid for controlling the dispensing of fluidized solids from the body member means to which it is detachably attachable;

(h) At least one elongated brush applicator means removably attachable to the upper lid of each of the first capping member means and being capable of extending downwardly from the upper lid of each of the first capping member means into the interior of each of the body member means, each of said elongated brush applicator means being fixedly and removably contained in an indented three-dimensional holding space of said holding palate; and

(i) At least one porous spherical and/or ellipsoidal pad applicator means removably attachable to each upper orifice rim of each of the body member means and designed to cover the entirety of each upper orifice rim of each body member means, each pad applicator means being capable of extending upwardly into the interior of each of said first capping member means; further characterized in that when the container is assembled and placed in an upright position and in a closed configuration, (i) the combined vertical outer surface of each of the base member means, the storage member means when present, the body member means and the capping member means form a substantially unitary continuous unbroken outer surface and (ii) the assembled container has the ability to be maintained in a stable upright configuration when placed on a substantially horizontal planar solid surface.

More specifically, and preferably, the kit assembly of our invention consists of:

(a) A container member means holding palate having twenty-one indented three-dimensional holding spaces for fixedly and removably holding container member means;

(b) Three liquid storage containers storing three different readily-utilizable first liquids, said storage containers being removably imbedded, respectively, in a first holding space, a second holding space and a third holding space;

(c) A hollow base member means storing a readily-utilizable first liquid, said base member means imbedded in a fourth holding space, said base member means having an outer liquid-impermeable vertically-disposed surface, a lower horizontally-disposed planar base and an upper horizontally-disposed orifice having an upper orifice rim;

(d) Three accessory storage containers storing three different groups of accessories said storage containers being removably imbedded, respectively, in a fifth holding space, a sixth holding space and a seventh holding space;

(e) A storage member means storing accessories imbedded in an eighth holding space, said storage member means having an outer liquid-impermeable vertically-disposed surface and having an upper section and a lower section, said storage member means being liquid-impermeable, said lower section being detachably and sealably attachable to the upper orifice rim of the upper orifice of said base member means;

(f) Three liquid storage containers storing three different readily-utilizable second liquids, said storage containers being removably imbedded, respectively, in a ninth holding space, a tenth holding space and an eleventh holding space;

(g) Three fluidized solid storage containers storing three different readily-utilizable fluidized solids, said fluidized solid storage containers being removably imbedded, respectively, in a twelfth holding space, a thirteenth holding space and a fourteenth holding space;

(h) A hollow body member means storing a second readily utilizable second liquid removably imbedded in a fifteenth holding space, said body member means having an outer liquid-impermeable vertically-disposed surface and a liquid-impermeable substantially planar horizontally-disposed base and having an upper horizontally-disposed orifice having an upper orifice rim, said body member means being detachably and sealably attachable at its base to the upper section of said storage member means and to the upper orifice of said base member means

(i) A hollow body member means storing a readily utilizable fluidized solid removably imbedded in a sixteenth holding space, said body member means having an outer fluidized solid-impermeable vertically-disposed surface and fluidized solid-impermeable substantially planar horizontally-disposed base and having an upper horizontally-disposed orifice having an upper orifice rim, said body member means being detachably and sealably attachable at its base to the upper section of said storage member means and to the upper orifice of said base member means;

(j) Downwardly positionable first applicator means removably imbedded in a seventeenth holding space, which applicator means has the capability of being either (i) externally attachable to the base of said body member means or (ii) externally attachable to the base of said storage member means, having the capability of extending downwardly therefrom into the interior of said base member for application of any of said readily-utilizable first liquids;

(k) Downwardly positionable second applicator means removably imbedded in a eighteenth holding space, which applicator means has the capability of being externally attachable to the underside of the lid of a first capping member means, having the capability of extending downwardly therefrom into the interior of said body member for application of any of said readily-utilizable second liquids;

(l) First capping means removably imbedded in a nineteenth holding space having a vertically-disposed outer liquid-impermeable vertically-disposed surface and an upper horizontally-disposed lid which is liquid-impermeable, said first capping means being detachably and sealably attachable to the rim of the upper orifice of said body member means;

(m) Second capping means removably imbedded in a twentieth holding space having a vertically-disposed outer fluidized solid-impermeable vertically-disposed surface and an upper horizontally-disposed lid which is fluidized solid-permeabilizable, said second capping means being detachably and sealably attachable to the rim of the upper orifice of said body member means; and

(n) Removably imbedded in a twenty-first holding space and attachable to the upper orifice rim of said body member means and capable of porously covering in its entirety said upper orifice and extending upwardly into the interior of said first capping means, second applicator means for application of any of said readily-utilizable second liquids;

further characterized in that when the container is assembled and placed in an upright position and in a closed configuration, (i) the combined vertical outer surface of each of the base member means, the storage member means when present, the body member means and the capping member means form a substantially unitary continuous unbroken outer surface and (ii) since the horizontal dimension of the lower horizontally-disposed substantially planar base, DBL is substantially greater than the horizontal dimension of the upper horizontally-disposed lid, DLU, the assembled container has the ability to be maintained in a stable upright configuration when placed on a substantially horizontal planar solid surface.

The construction materials useful in fabricating the container members of our invention may be identical for each member of the container of our invention or the construction materials for each member may be dissimilar from one-another. The construction materials include, interalia, colored and non-colored transparent, translucent and opaque glasses or polymers, and, in addition, metallic substances. More specifically, the construction materials for each member of the container of our invention may be:

Clear Glass, e.g., PYREX® (Registered trademark of Corning Inc. of Corning, N.Y., U.S.A.);

Stainless steel;

Pigmented glass, e.g., blue pigmented glass or brown pigmented glass which, due to the inclusion of the pigment, inhibits decomposition of the substance contained in the container member caused by ultraviolet radiation exposure;

Cross-linked pigmented phenol-formaldehyde resins, e.g., BAKELITE® (registered trademark of Georgia-Pacific Resins, Inc. of Atlanta, Ga., U.S.A.);

Cross-linked transparent polymethyl methacrylate resins, e.g., PLEXIGLAS® (Registered trademark of Rohm & Haas Company Corporation of Philadelphia, Pa., U.S.A.);

High molecular weight polypropylene;

High molecular weight polyethylene;

Cross-linked melamine-formaldehyde resins, e.g., MELMAC® (Registered trademark of Cytec Technology Corp. of Wilmington, Del., U.S.A.);

Cross-linked urea-formaldehyde resins, e.g., PLASKON® (Registered trademark of Amoco Chemical Co. of Chicago, Ill., U.S.A.);

Polyvinyl chloride, e.g., VINYLITE® (Registered trademark of Carbide & Carbon Chemicals Corp. of New York, N.Y., U.S.A.);

Polyethylene terephthalate, e.g., as disclosed in Nelsen, U.S. Pat. No. 4,539,356 issued on Sep. 5, 1985, the disclosure of which is incorporated herein by reference;

Pigmented cross-linked polyacetal resins, e.g., DELRIN® (Registered trademark of E. I. Du Pont de Nemours and Company of Wilmington, Del., U.S.A.);

Thermosetting alkyd resins, e.g., BECKACITE® (Registered trademark of Reichhold Chemicals, Inc. of White Plains, N.Y., U.S.A.); and

Pigmented cross-linked high molecular weight epoxy resins, e.g., those formed by means of the reaction of bis-phenol-A with epichlorohydrin, cross-linked with phthalic anhydride.

Thus, for example, when used for two fragrance materials, the frusto-conical base member means and the frusto-conical base member means is preferably fabricated from a brown-pigmented PYREX® glass, whereas the frusto-hyperbolic-shaped walls connecting the walls of the base member means and the body member means, as well as the capping member means is preferably fabricated from a black-pigmented cross-linked phenol-formaldehyde polymer, e.g., BAKELITE®. However, when the container of our invention is used for (i) nail polish and (ii) nail polish remover, or for (i) a liquid lip stick suspension and (ii) a liquid mascara suspension, then each of the frusto-conical base member means and the frusto-conical body member means is preferably fabricated from a transparent polymer, e.g., cross-linked polymethyl methacrylate, e.g., PLEXIGLAS® whereas the frusto-hyperbolic connecting wall or storage member, if used, as well as the capping member means is preferably fabricated from a pigmented polyacetal resin, e.g., DELRIN®, or a pigmented melamine-formaldehyde resin, e.g., MELMAC® or a pigmented cross-linked phenol-formaldehyde polymer, e.g., BAKELITE®.

The term, ‘liquid’ is herein intended to include substances existing in the single liquid phase or bi-phasic liquids or poly-phasic liquids e.g., water-in-oil emulsions or water-in-oil emulsions, or multiple emulsions or particulate suspensions of solids in liquids, e.g., nail polish, nail polish having nail glitter suspended therein, liquid eye mascara and the like, at ambient conditions, e.g., in the range of from about 13 pounds per square in absolute pressure up to about 17 pounds per square inch absolute pressure and from about 15° C. up to about 40° C. temperature, which ‘liquid’ substances are pourable and/or coatable via the application means of our invention, e.g., brush or porous substance applicators and, accordingly, which substances may conveniently and controllably be dispensed from the container of our invention at ambient conditions. The viscosities and densities of such ‘liquids’ may thus vary over a wide range and are functions of the desired rates that the materials are to be efficaciously dispensed from each of the container members. Thus, for example, a useful liquid density of a liquid useful in the practice of our invention is in the range of from about 0.8 gm/cc up to about 2 gm/cc at ambient conditions and a useful viscosity of a liquid useful in the practice of our invention is in the range of from about 0.5 centipoises (e.g., the viscosity of solvents such as ethanol) up to about 700 centipoises (the viscosity of slow-flowing polymer compositions such as nail lacquer) at ambient conditions.

The term ‘fluidized solid’ is herein intended to mean a microparticulate solid having particle size ranges such that the solid may be conveniently and controllably dispensed from the body member means of our invention via the capping member means of our invention through the permeabilizable lid of the capping member means, for example particles having effective diameters in the range of from about 5 microns up to about 2 mm, e.g., talc and nail glitter as well as micro-encapsulated fragrances such as those produced by coacervation of a gelatin wall about a liquid perfume center or by spray drying or freeze drying a fragrance formulation with a carrier such as starch or a modified starch.

The term ‘permeabilization’ is herein intended to mean enablement of a fluidized solid as defined supra to be controllably dispensed at desired rates from the lid of the capping member means, for example through a multiplicity of orifices in the lid, which orifices have openings having adjustable diameters of from 0 up to about 2 mm or through a screen covering an orifice extending over substantially the entire lid of the capping member which screen has adjustable mesh sizes enabling controlled passage therethrough of particles having diameters of from about 5 microns up to about 2 mm, for example.

The compartmentalized container and kit for assembling same of our invention has a multitude of diverse uses in a multitude of diverse arts including, but not limited to the cosmetic arts (e.g., permutations of the components: nail polish, nail lacquer, nail glitter, nail lacquer curing agent, mascara, eye shadow, liquid lipstick, liquid and/or cream deodorants, liquid and/or cream anti-perspirants and solvents therefor), the decorative arts (e.g., combinations of various oil paints and/or oil paint lacquers and solvents therefor), the photographic arts (e.g., combinations of various liquid fixatives and liquid developers and solvents therefor), the pharmaceutical arts (e.g., combinations of various microencapsulated medicinals, liquid antiseptics, liquid eye drops, liquid medicinals and solvents therefor), the perfumery arts (e.g., combinations of various liquid perfumes, perfume emulsions, solvents therefor and microencapsulated perfumes) and the insect repellency arts (e.g., combinations of liquid insect repellents, solvents therefor and microencapsulated insect repellents).

More specifically, the content of the following Table I is indicative of the specific arts and techniques in which the container of our invention can be employed:

TABLE I

| | | | Capping | |
|---|---|---|---|---|
| | | | Member | |
| | | | Means | Accessories |
| | Contents of | Contents of | Attach- | in Storage |
| Art | Base Member | Body Member | ment | Member |
| Cosmetic- | Nail Polish | Nail Polish | Brush | Nail Polish |
| Nail Care | | Remover | | Remover |
| | | | | Pads |
| Cosmetic- | Nail Polish | Nail Polish | Brush | None |
| Nail Care | | Remover | | |
| Cosmetic- | Nail Lacquer | Nail Lacquer | Brush | None |
| Nail Care | | Curing | | |
| | | Agent* | | |
| Cosmetic- | Nail Polish | Nail Glitter | None | None |
| Nail Care | | | | |
| Cosmetic- | Nail | Nail | Brush | Adhesive |
| Nail Care- | infection | infection | | Tape |
| Medicinal | treatment | treatment | | Section |
| | composition | composition | | |
| | component** | component** | | |
| Cosmetic- | Nail Polish | Fragrance | None | None |
| Fragrance/ | | | | |
| Nail Care | | | | |
| Cosmetic- | Liquid Eye | Liquid | Brush | Blotting |
| Eye Makeup | Shadow | Mascara | | Pads |
| Cosmetic- | Liquid Skin | Liquid Anti- | Brush | Blotting |
| Body Care | Cleaner | Bacterial | | Pads |
| | | Composition | | |
| Cosmetic- | Liquid Skin | Powder Anti- | None | Antiseptic |
| Body Care | Cleaner | Bacterial | | Pads |
| | | Composition | | |
| Cosmetic- | Liquid Skin | Powder Anti- | None | Pain Relief |
| Body Care | Cleaner | Bacterial | | Pads |
| | | Composition | | |
| Cosmetic- | Liquid Lip | Liquid | Brush | None |
| Makeup | Gloss | Lipstick | | |
| Cosmetic- | Liquid Eye | Liquid Eye | Brush | None |
| Makeup | Shadow | Liner | | |
| Medicinal | Liquid | Wound | Brush | Isopropanol- |
| | Antiseptic | Dressing | | containing |
| | | Lacquer | | mini-wipes |
| Fragrance- | Liquid | Liquid | Brush | None |
| Insect | Fragrance | Insect | | |
| Repellency | Composition | Repellent | | |
| Insect | Liquid | Micro- | None | None |
| Repellency | Insect | encapsulated | | |
| | Repellent | Insect | | |
| | | Repellent | | |
| Insect | Liquid | Liquid | Brush | None |
| Repellency | Insect | Fragrance | | |
| | Repellent | | | |
| Photography | Liquid | Liquid | None | None |
| | Developer | Fixative | | |
| Cosmetic- | Liquid | Liquid or | Porous | Anti- |
| Perfumery/ | Fragrance | Cream | stiff | perspirant |
| Body Care | | Deodorant | applicator | pads |
| Decorative | Decorative | Oil Paint | Brush | Solvent- |
| Arts | Oil Lacquer | | | containing |
| | | | | Wipes |
| Cosmetic- | Liquid | Encapsulated | None | None |
| Perfumery | Fragrance | Fragrance | | |

Note
*Nail lacquer-nail lacquer curing agent compositions and processes for using same are disclosed, for example, in Sawyer, U.S. Pat. No. 6,401,724 issued on Jun. 11, 2002, the disclosure of which is incorporated herein by reference.
Note
**Nail infection treatment composition components and methods of utilizing same are disclosed, for example, in Lee, U.S. Pat. No. 6,413,555 issued on Jul. 2, 2002, the disclosure of which is incorporated herein by reference.

### BRIEF DESCRIPTION OF THE DRAWINGS

FIG. 1 is a side view of a first embodiment of the compartmentalized container of our invention which is a bi-compartmentalized container, shown in an upright position.

FIG. 2 is a cut-away side-elevation view of the embodiment of the compartmentalized container shown in FIG. 1.

FIG. 3 is an exploded side-elevation view of the upper section of the embodiment of the compartmentalized container shown in FIG. 1.

FIG. 4 is an exploded side-elevation view of the lower section of the embodiment of the compartmentalized container shown in FIG. 1.

FIG. 5A is a side view of a second embodiment of the compartmentalized container of our invention which is a bi-compartmentalized container, shown in an upright position.

FIG. 5B is an exploded side-elevation view of the second embodiment of the compartmentalized container of our invention shown in FIG. 5A.

FIG. 6A is a side view of a third embodiment of the compartmentalized container of our invention which is a bi-compartmentalized container, shown in an upright position.

FIG. 6B is an exploded side-elevation view of the third embodiment of the compartmentalized container of our invention shown in FIG. 6A.

FIG. 7A is a side view of a fourth embodiment of the compartmentalized container of our invention which is a bi-compartmentalized container, shown in an upright position.

FIG. 7B is an exploded side-elevation view of the fourth embodiment of the compartmentalized container of our invention shown in FIG. 7A.

FIG. 8A is a side view of a fifth embodiment of the compartmentalized container of our invention which is a bi-compartmentalized container, shown in an upright position.

FIG. 8B is an exploded side-elevation view of the fifth embodiment of the compartmentalized container of our invention shown in FIG. 8A.

FIG. 9A is a side view of a sixth embodiment of the compartmentalized container of our invention which is a tri-compartmentalized container, shown in an upright position including an internal accessory-holding compartment.

FIG. 9B is an exploded side-elevation view of the sixth embodiment of the compartmentalized container of our invention shown in FIG. 9A.

FIG. 10A is a side view of a seventh embodiment of the compartmentalized container of our invention which is a tri-compartmentalized container, shown in an upright position including an internal accessory-holding compartment.

FIG. 10B is an exploded side-elevation view of the seventh embodiment of the compartmentalized container of our invention shown in FIG. 10A.

FIG. 11A is a side view of the fifth embodiment of the compartmentalized container of our invention which is a bi-compartmentalized container, partially exploded, showing the upper cap removed, with the upper compartment ready for use.

FIG. 11B is a side view of the fifth embodiment of the compartmentalized container of our invention, partially exploded, showing the upper cap attached, with the lower compartment separated from the upper compartment, with the applicator attached to the upper compartment ready for use in conjunction with the contents of the lower compartment.

FIG. 12A is a perspective view of a prior art compound container as published in “Practical and Innovative Package”, Export Magazine, No. 5, 14, July/August, 1994, Page 57; Published by Associazione Nazionale Grossisti Italiani Profumeria of Rome, Italy.

FIG. 12B is an exploded perspective view of the prior art container of FIG. 12A.

FIG. 13A is a side view of an eighth embodiment of the compartmentalized container of our invention which is a tri-compartmentalized container, shown in an upright position. where the upper compartment contains a fluidized solid, e.g., nail “glitter”.

FIG. 13B is an exploded side-elevation view of the eighth embodiment of the compartmentalized container of our invention shown in FIG. 13A.

FIG. 13C is another exploded side-elevation view of the eighth embodiment of the compartmentalized container of our invention shown in FIG. 13A showing the fluidized solid, e.g., nail “glitter” partially removed from the upper compartment.

FIG. 14A is a perspective view of a first embodiment of a cap having an upper lid, a substantial portion of which is in the form of a screen and is thus porous to fluidized solids, e.g., nail “glitter”, which cap is employed as part of the eighth embodiment of the compartmentalized container of our invention, shown in FIG. 13A.

FIG. 14B is a perspective view of a second embodiment of a cap having upper lid, which lid contains a multiplicity of small circular orifices and is thus porous to fluidized solids, e.g., nail “glitter”, which cap is employed as part of the eighth embodiment of the compartmentalized container of our invention, shown in FIG. 13A.

FIG. 15A is a side view of a modification of the second embodiment of the compartmentalized container of our invention, shown in an upright position, wherein a wall support is detachably affixed to the upper rim of the upper compartment of the bi-compartmentalized container.

FIG. 15B is an exploded side-elevation view of the modified second embodiment of the compartmentalized container of our invention shown in FIG. 15A wherein a wall support is detachably affixed to the upper rim of the upper compartment of the bi-compartmentalized container.

FIG. 15C is a detailed side-elevation view of the upper section of the upper compartment of the modified second embodiment of the compartmentalized container of our invention shown in FIG. 15A wherein a wall support is detachably affixed to the upper rim of the upper compartment of the bi-compartmentalized container.

FIG. 15D is a detailed perspective view of the upper section of the upper compartment of the modified second embodiment of the compartmentalized container of our invention shown in FIG. 15A wherein a wall support is detachably affixed to the upper rim of the upper compartment of the bi-compartmentalized container.

### DETAILED DESCRIPTION OF THE DRAWINGS

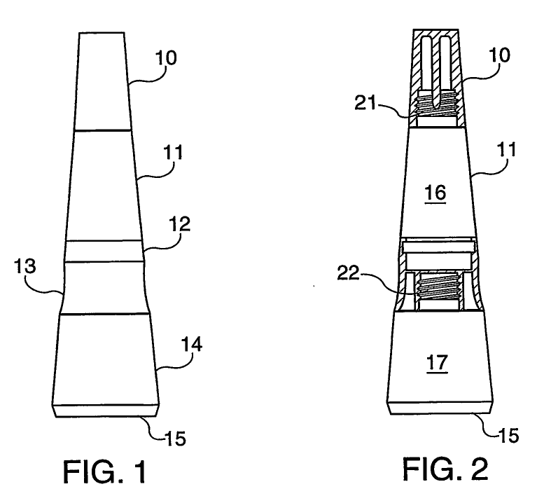

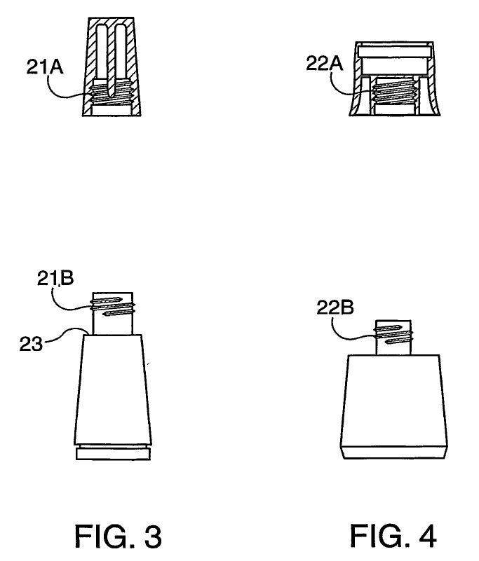

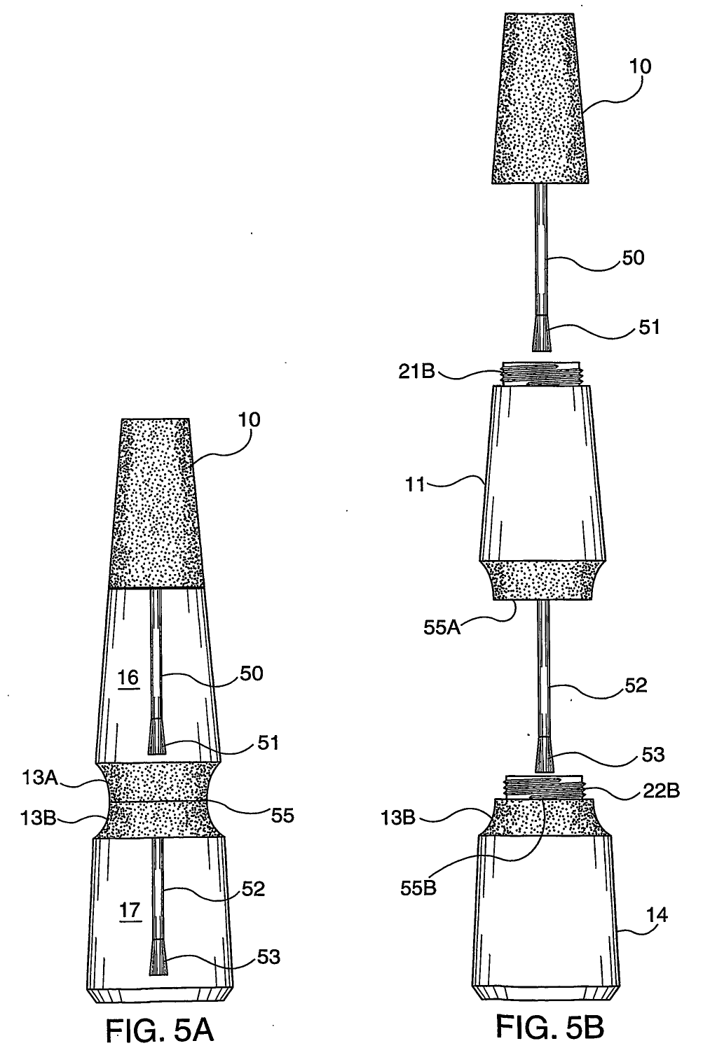

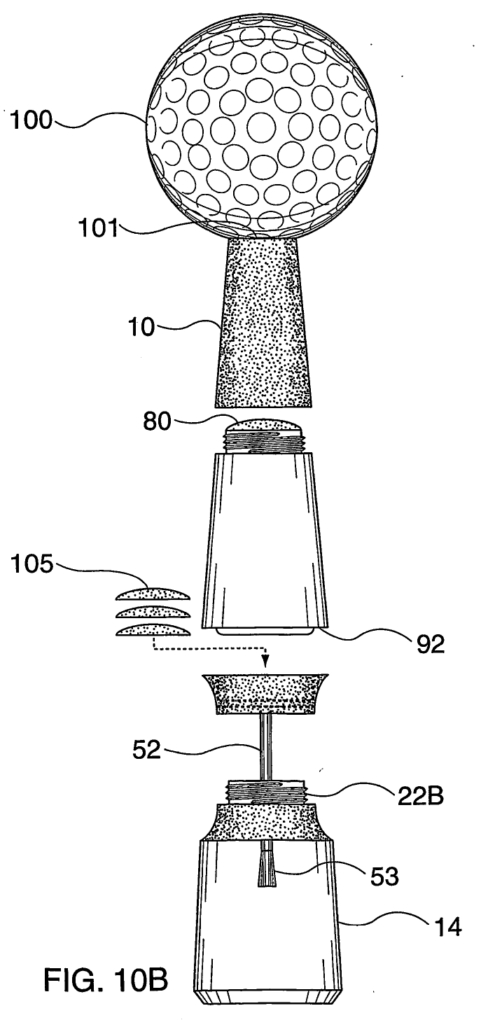

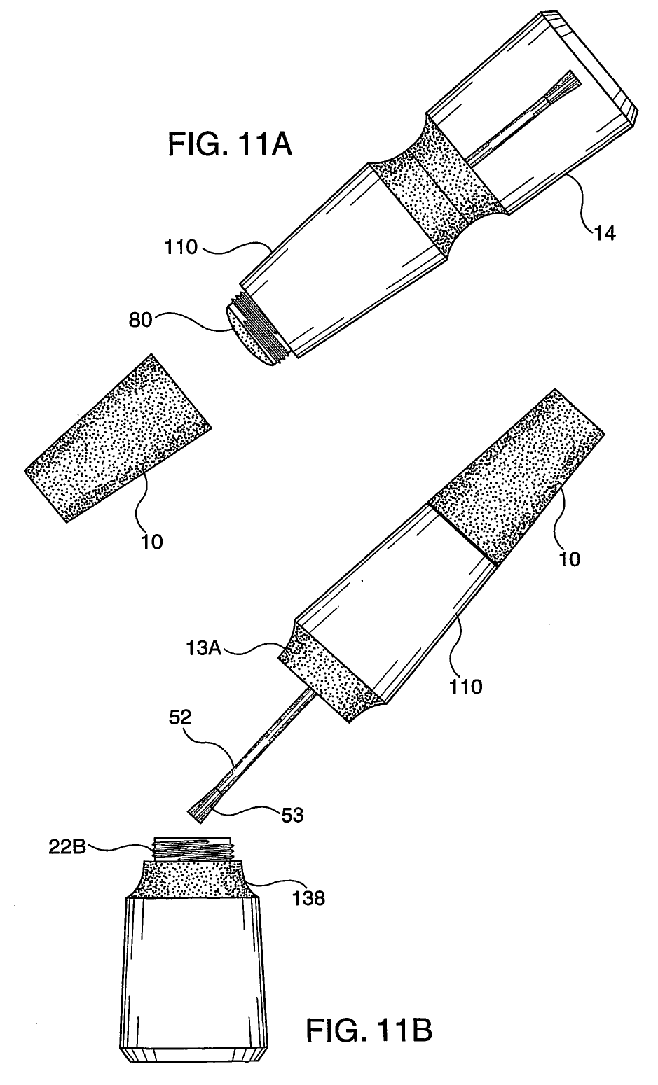

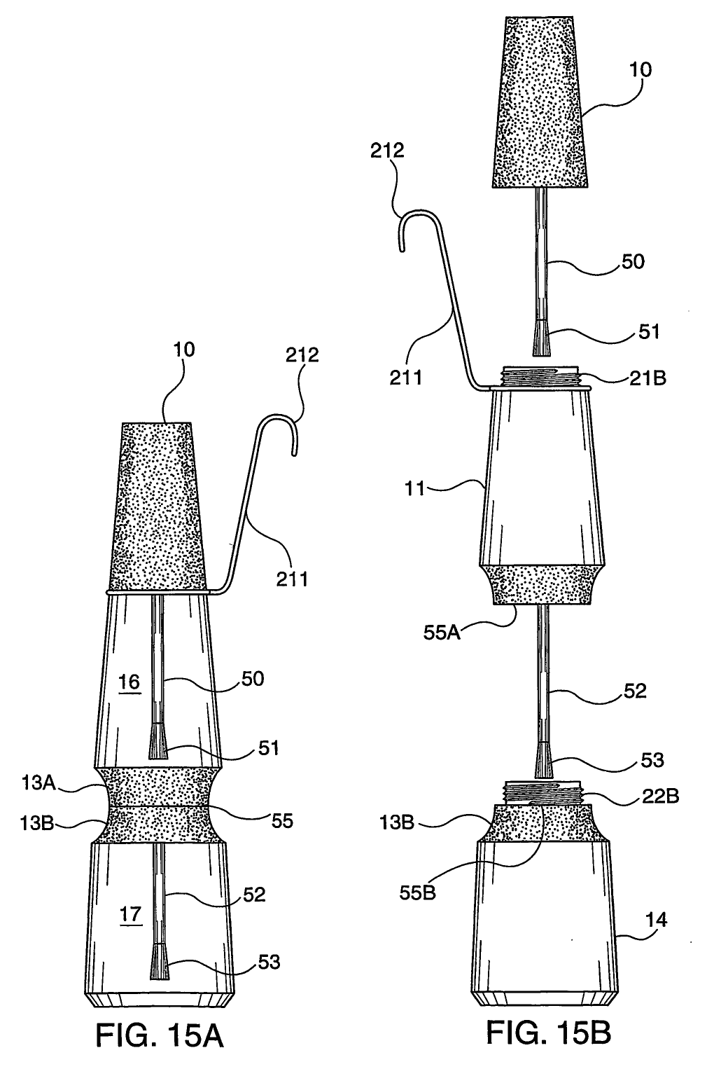

Referring to FIGS. 1-4, 9A, 9B, 10A, 10B, 13A, 13B, 13C, 14A and 14B, showing a compound hollow container 900 (shown as such in FIG. 9A) having three compartments for containing, storing and dispensing two liquids or a liquid in the lower compartment and a fluidized solid in the uppermost compartment, in and from two of the compartments, e.g., nail polish and nail polish remover or nail glitter, and accessories therefor, e.g., nail wipes 88 (shown in FIG. 9B) and 105 (shown in FIG. 10B) in and from the third centrally-located compartment, as well as a capping member therefor (shown in FIGS. 3, 15A and 15B), the container 900 (shown as such in FIG. 9A) consists of:

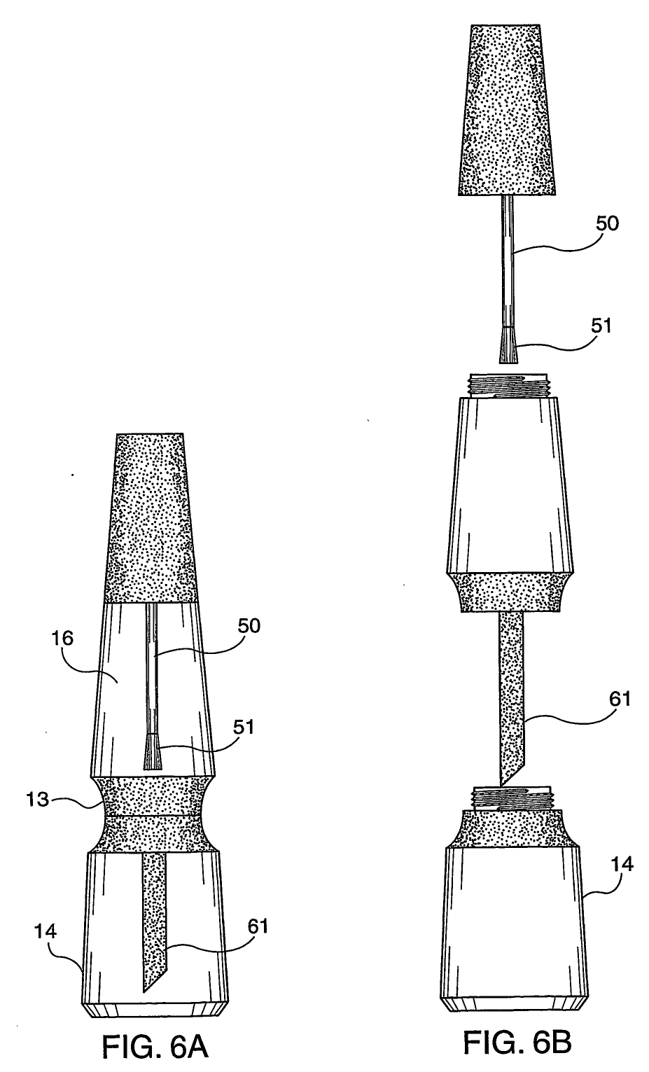

(a) A hollow base member 17 in the shape of a conical frustum having a lower planar base 10 having a larger dimension than its upper base, which upper base has an orifice therethough, the bases being connected by a liquid-impermeable frusto-conical wall 14. The orifice of the upper base is surrounded by an upwardly extended externally screw-threaded cylinder 22B (shown in FIG. 4). The upwardly extended externally-threaded cylinder is surrounded by an upwardly-extended frusto-hyperboloid 130B (shown in FIGS. 9A and 9B) having diminishing radii as it is upwardly extended;

(b) Attached to the hollow base member 17 via mating screw threads located on the internal surface of a lower internally-situated circular cylinder 22A is a storage member means (shown by reference numeral 93 in FIG. 9B) having a frusto-hyperboloid outer surface 13 (shown in FIG. 1) or 130A (shown in FIGS. 9A and 9B) fully abutting at 131 (shown in FIG. 9B) a lower circular rim having the same diameter and circumference as the upper base rim of hollow base member 17 and juxtaposed thereto at its base. The upper base of the storage member means has an orifice therethrough surrounded by a circumventing circular rim (shown by reference numeral 91 in FIGS. 9A and 9B). The upper rim 91 (shown in FIGS. 9A and 9B) of the storage member means has a circumferential snap-fit fitting having the same radius and circumference and mating with a snap-fit fitting 92 (shown in FIG. 9B) located on the rim circumventing the base of the body member means 16, described infra. Attached to the center of the lower base of storage member means 93 is an applicator shown by reference numerals 52 (the shaft) and 53 (the brush) (shown in FIGS. 9B, 10A and 10B) extending downwardly along the vertical axis of cylinder 22 into the inner space of the base member 17.

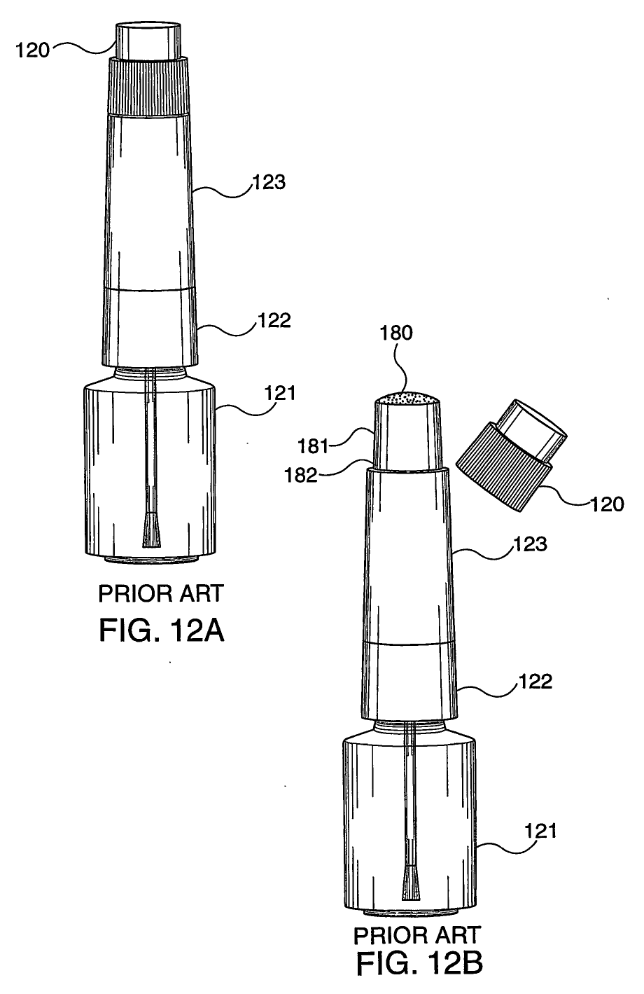

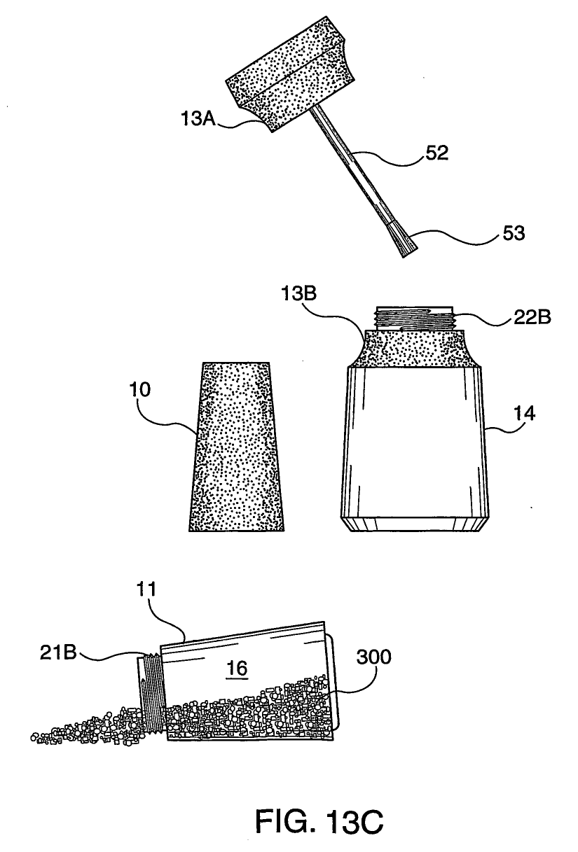

(c) Accordingly, attached to the upper base of the storage member means via two mating snap-fit fittings (including fitting 92 shown in FIG. 10B) is a hollow body member means 16 having a frusto-conical surface 110 (shown in FIGS. 9A and 9B) or 11 (shown in FIGS. 1, 2, 13A, 13B, and 13C) extending from its lower base rim circumvented by a snap-fit fitting 92 (shown in FIG. 9B) to an upper base 95 (shown in FIG. 9B) surrounded by an upper base rim and having an aperture therethrough. Circumventing the aperturee of the upper base and extending upwardly therefrom is cylinder 21B (shown in FIGS. 3, 9B and 13C) threaded on its outer surface with a screw thread which mates with, and which is juxtaposed with a screw thread located on the inner surface of a downwardly-directed cylinder 21A located within the lower section of the inner portion of capping member means 10. The upper rim of cylinder 21B may be covered with a porous liquid applicator 80 (constructed, for example from sponge natural rubber or polyurethane foam produced from tolylene diisocyanate, dimer acid and dibutylene glycol) (shown in FIGS. 9A and 9B) or the orifice surrounded by the upper rim may be open and a fluidized solid, 300, e.g., nail glitter by me employed in body member means 16 as shown in FIGS. 13A and 13B.

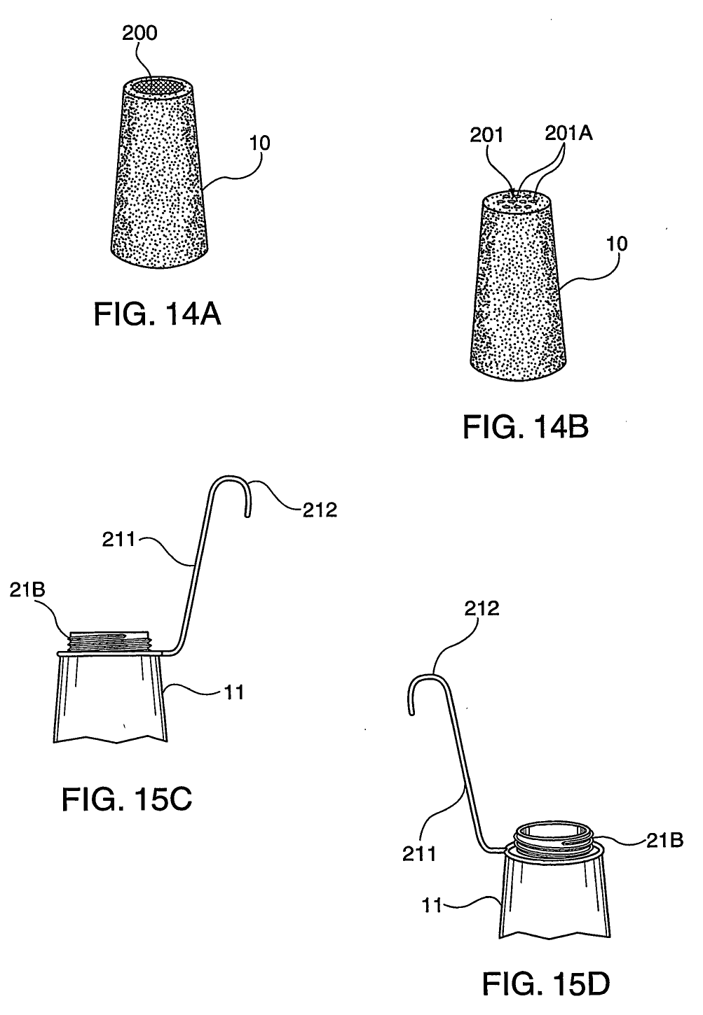

(d) Accordingly, attached to the upper base of body member means 16 via two mating juxtaposed screw fittings on cylinders 21A and 21B is capping member means 10. The capping member may have a solid liquid-impermeable horizontally-disposed upper lid 101 (as shown in FIGS. 10A and 10B) which may have permanently affixed thereto a leveraged opening means 100 shown in the shape of a golf ball in FIGS. 10A and 10B); or the horizontally-disposed upper lid of the capping member means may be fluidized solid-permeabilizable for example (i) by including an adjustable set of orifices 201A (which orifices have variable diameters from 0 up to about 2 mm) in the upper lid 201 as set forth in FIG. 14B or (ii) by including an adjustable fine mesh screen 200 in the upper lid as set forth in FIG. 14A (which screen has a variable mesh size permitting particles up to 2 mm in diameter to pass through the screen 200).

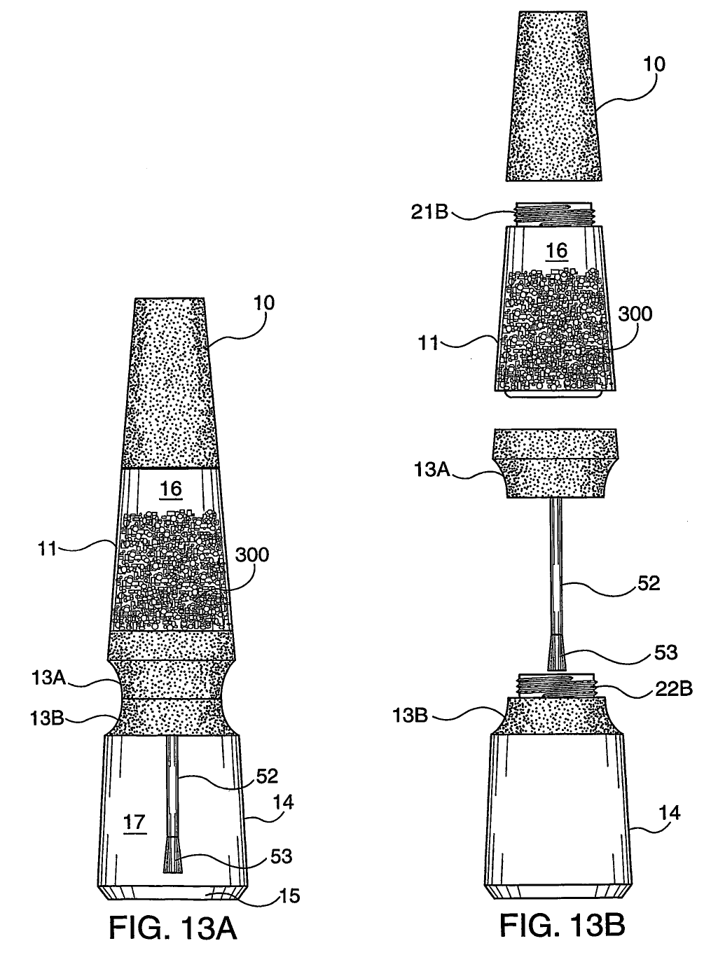

Referring to FIGS. 12A and 12B showing a prior art article, cylindrical base member 121 (which can contain nail polish, for example) is covered with a cylindrical lid 122 attached via two mating screw fittings to the base member 121, but having a significantly pronounced indent between the lid member 122 and the base member 121. Attached to the lid via two mating snap-fit rim fittings is body member 123 (which can contain nail polish remover, for example). Attached to the upper rim 182 of body member 123 is a hollow cylinder 181 into which is inserted application or cleaning pads 180. Cylinder 181 is protected by snugly fitting cap 120.

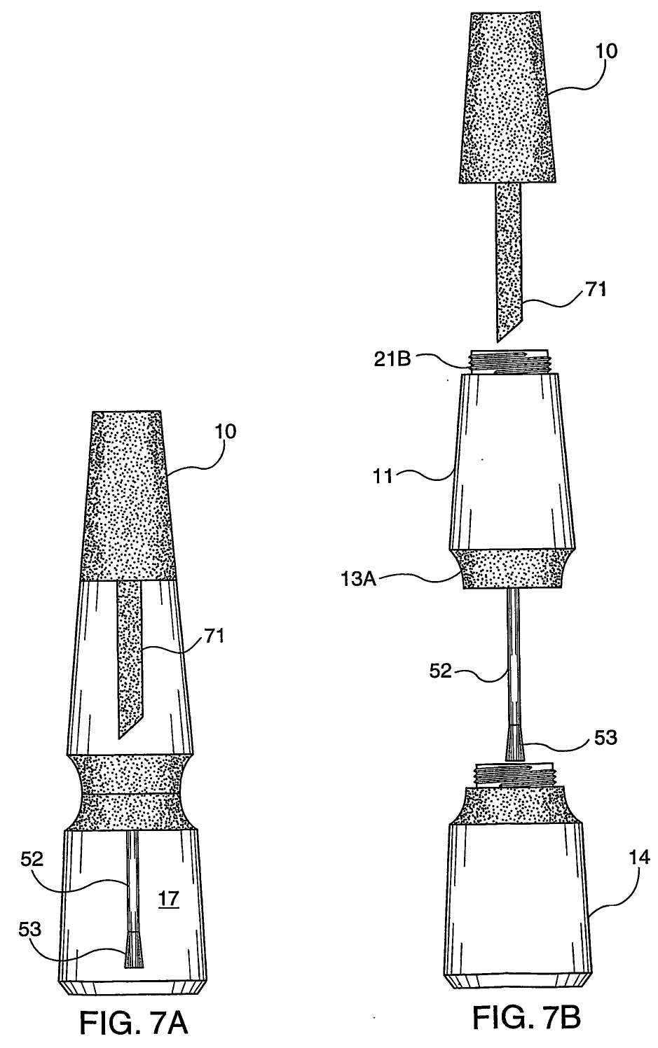

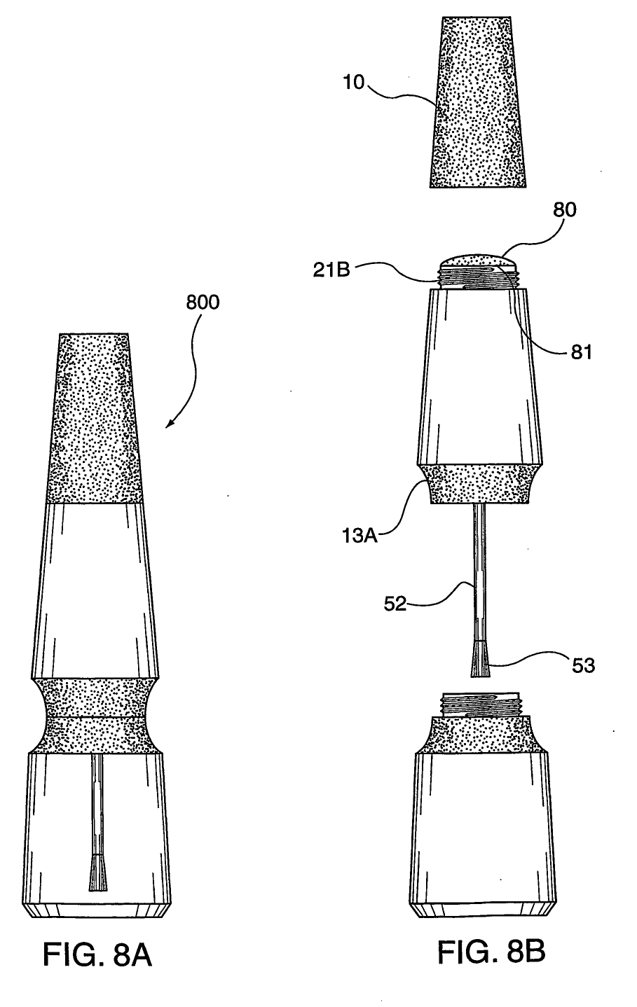

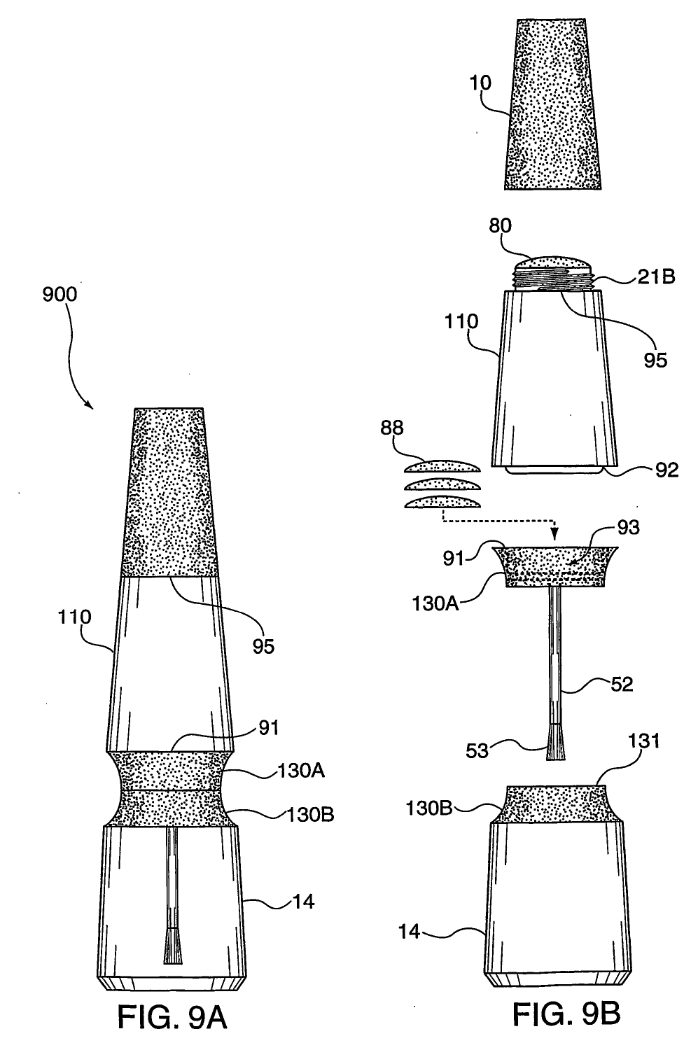

Referring to FIGS. 5A, 5B, 6A, 6B, 7A, 7B, 15A and 15B, each of which shows a compound hollow bi-compartmentalized container capable of containing, storing and dispensing readily-utilizable liquids and equipped with liquid applicators for each of the liquids the container consists of:

(a) A vertically-disposed hollow base member 17 having a hollow vertically-disposed frusto-conical base section 14 having a planar circular liquid-impermeable first solid base and having a first circular rim; extending upwardly from the entire circumference of said first circular rim a substantially vertically-disposed liquid-impermeable solid thin cylindrical wall surrounding a first volume V₁ terminating at an upper horizontal second circular rim; fixedly fused to the entirety of the said second circular rim and extending upwardly, a vertically-disposed outwardly concave upwardly convergent frusto-hyperbolic section 13B having a thin liquid-impermeable solid wall terminating at an upper horizontal third circular rim 55B fully circumventing a first horizontal aperture; and fixedly fused to said third circular rim a first vertically-disposed cylindrical section having a liquid-impermeable thin solid cylindrical wall and an inner first cylinder surface and an outer first cylinder surface 22B, said outer first cylinder surface being horizontally threaded with a first thread pitch ρ and a thread depth Δ, said first cylindrical section fully circumventing the entirety of a second horizontally disposed aperture;

(b) Removably attached to said hollow base member 17 onto said first vertically-disposed cylindrical section, a vertically-disposed hollow body member 16 having a hollow vertically-disposed frusto-conical body section having a horizontally-disposed planar circular liquid-impermeable second solid base having a fourth circular rim circumventing said second solid base; fixedly attached proximate the center of said second solid base, and extending vertically downwardly therefrom into the interior of said frusto-conical base section a first applicator member 52 terminating in applicator brush 53 or, in the alternative, a rigid absorbent applicator 61 constructed of a natural sponge, or a cross-linked polystyrene foam, e.g., STYROFOAM® (Registered Trademark of The Dow Chemical Company of Midland, Mich., U.S.A.), or a polyurethane foam, e.g., a material produced, for example, by reacting tolylene diisocyanate with dimer acid and a polypropylene glycol; fixedly fused to the entirety of said fourth circular rim and extending downwardly, a vertically-disposed outwardly concave downwardly convergent frusto-hyperbolic section 13A having a thin liquid-impermeable wall terminating at a lower horizontal fifth circular rim 55A circumventing a third horizontally-disposed aperture which is co-planar with said second horizontally-disposed aperture; fixedly fused to the entirety of said lower horizontal fifth circular rim 55A, and extending upwardly therefrom, within the confines of said downwardly convergent frusto-hyperbolic section, in a direction perpendicular to the plane of said third horizontally-disposed aperture, a second vertically-disposed cylindrical section having a liquid or fluidized solid-impermeable thin solid wall having an inner second cylinder surface and an outer second cylinder surface, said inner second cylinder surface being horizontally threaded with a second thread having a thread pitch ρ′ and a thread depth Δ′, said second thread mating with and being juxtaposed and removably sealably cooperating with said first thread of said first cylindrical section of said base member (a); extending upwardly from the entirety of said fourth circular rim a substantially vertically-disposed liquid-impermeable solid thin wall 11 surrounding a second volume V₂ terminating at an upper horizontally-disposed sixth circular rim; fixedly fused to the entirety of said sixth circular rim and extending upwardly therefrom in a direction perpendicular to the plane of said third horizontally-disposed aperture, a third vertically-disposed cylindrical section 21B having a liquid-impermeable thin solid wall having an inner third cylinder surface and an outer third cylinder surface, said outer third cylinder surface being horizontally threaded with a third thread having a thread pitch ρ″ and a thread depth AΔ″, said third cylinder wall terminating at a seventh circular rim circumventing a fourth horizontally-disposed aperture; and

(c) Removably attached to said hollow body member 16 onto said third vertically disposed cylinder section, a container capping member 10 having a horizontally-disposed liquid-impermeable solid circular planar lid member circumvented by an eighth circular rim; fixedly fused to, and extending downwardly from the entirety of the circumference of said eighth circular rim, an outwardly, downwardly expanding frusto-conical wall terminating at the inner portion thereof in a fourth cylindrical section having a fourth inner cylindrical surface and a fourth outer cylindrical surface, said fourth inner cylindrical surface being horizontally threaded with a fourth thread having a thread pitch, ρ″′ and a thread depth, Δ″′, said fourth thread mating with, being juxtaposed with, and sealably cooperative with said third thread of said third cylindrical section 21B of said hollow body member; optionally fixedly attached proximate the center of said third solid planar base, and extending vertically downward therefrom into the interior of said frusto-conical body section, in a direction perpendicular to the plane of said third solid planar base, a second applicator 50 terminating in application brush 51 or, in the alternative, rigid absorbent applicator 71 constructed of a natural sponge material or a polystyrene foam material e.g., STYROFOAM® or a polyurethane foam material. Optionally, container suspending means such as a wire wall support member having bendable metal (e.g., stainless steel, copper or cupro-nickel) wire shaft 211 and hook 212 may be attached to the container of our invention, preferably at the upper. horizontally-disposed sixth circular rim at which capping member wall 11 terminates, located at the base of cylindrical section 21B.

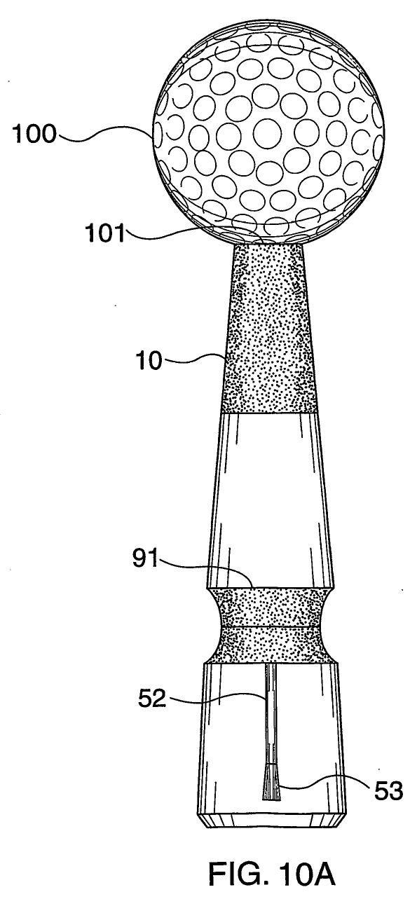

Referring to FIGS. 8A, 8B, 11A and 11B each of which shows a container which is a compound hollow bi-compartmentalized container 800 capable of containing, storing and dispensing readily-utilizable liquids and equipped with liquid applicators for each of the liquids, the container 800 consists of:

(a) A vertically-disposed hollow base member 14 having a hollow vertically-disposed frusto-conical base section having a planar circular liquid-impermeable first solid base of radius R₁ of from about 1 cm up to about 2 cm and having a first circular rim having a length of 2πR₁; extending upwardly from the entire circumference of said first circular rim a substantially vertically-disposed liquid-impermeable solid thin cylindrical wall having a height H₁ of from about 2.5 cm up to about 5.0 cm surrounding a first volume V₁ of from about 20 cc up to about 100 cc terminating at an upper horizontal second circular rim having a radius R₂ of from about 1 cm up to about 2 cm; fixedly fused to the entirety of the said second circular rim and extending upwardly therefrom, a vertically-disposed outwardly concave upwardly convergent frusto-hyperbolic section 138 having a height H₂ of from about 0.5 cm up to about 1.5 cm and having a thin liquid-impermeable solid cylindrical wall terminating at an upper horizontal third circular rim fully circumventing a first horizontal aperture having a radius R₃ of from about 0.5 up to about 1.5 cm with the proviso that R₂>R₃; and fixedly fused to said third circular rim a first vertically-disposed cylindrical section 22B having a liquid-impermeable thin solid cylindrical wall and a height H₃ of from about 0.5 cm up to about 1.0 cm and an inner first cylinder surface and an outer first cylinder surface, said outer first cylinder surface being horizontally threaded with a first thread pitch ρ and a thread depth Δ, said first cylindrical section fully circumventing the entirety of a second horizontally disposed aperture of radius R₃;

(b) Removably attached to said hollow base member onto said first vertically-disposed cylindrical section, a vertically-disposed hollow body member having a hollow vertically-disposed frusto-conical body section 110 having a horizontally-disposed planar circular liquid-impermeable second solid base of radius R₂′ of from about 1 cm up to about 2 cm having a fourth circular rim circumventing said second solid base; fixedly attached proximate the center of said second solid base, and extending vertically downwardly therefrom into the interior of said frusto-conical base section 14 a first applicator shaft member 52 terminating in an application brush 53 having a length L₁ of from about 3.0 cm up to about 6.5 cm with the proviso that H₁≦L₁≦[H₁+H₂+H3]; fixedly fused to the entirety of said fourth circular rim and extending downwardly, a vertically-disposed outwardly concave downwardly convergent frusto-hyperbolic section 13A having a height H₂′ of from about 0.5 cm up to about 1.5 cm and having a thin liquid-impermeable wall terminating at a lower horizontal fifth circular rim circumventing a third horizontally-disposed aperture of radius R₃′ which is co-planar with said second horizontally-disposed aperture, with the proviso that R₃=R₃′; fixedly fused to the entirety of said lower horizontal fifth circular rim, and extending upwardly therefrom, within the confines of said downwardly convergent frusto-hyperbolic section, in a direction perpendicular to the plane of said third horizontally-disposed aperture, a second vertically-disposed cylindrical section having a liquid impermeable thin solid wall of height H₃′ of from about 0.5 cm up to about 1 cm and an inner second cylinder surface and an outer second cylinder surface, said inner second cylinder surface being horizontally threaded with a second thread having a thread pitch ρ′ and a thread depth Δ′, said second thread mating with, being juxtaposed and removably sealably cooperating with said first thread of said first cylindrical section of said base member (a); extending upwardly from the entirety of said fourth circular rim a substantially vertically-disposed liquid-impermeable solid thin cylindrical wall having a height H₁′ of from about 2.5 cm up to about 5.0 cm surrounding a second volume V₂ of from about 20 cc up to about 100 cc terminating at an upper horizontally-disposed sixth circular rim having a radius R₂′ of from about 1 cm up to about 2 cm; fixedly fused to the entirety of said sixth circular rim and extending upwardly therefrom in a direction perpendicular to the plane of said third horizontally-disposed aperture, a third vertically-disposed cylindrical section 21B having a liquid-impermeable thin solid wall and a height H₄ of from about 0.5 cm up to about 1.0 cm and an inner third cylinder surface and an outer third cylinder surface, said outer third cylinder surface being horizontally threaded with a third thread having a thread pitch ρ″ and a thread depth Δ″, said third cylinder wall terminating at a seventh circular rim 81 circumscribing a fourth horizontally-disposed aperture having a radius R₄ of from about 1 cm up to about 2 cm with the proviso that R₄≦R₃; removably attached to the entirety of said seventh circular rim and fully covering and fitting within said fourth circular aperture, a porous hemispheroidal second applicator means 80 (i) having a central circular plane of radius R₄′, where R₄=R₄′, coplanar with said aperture; (ii) having a central substantially vertical axis substantially perpendicular to the plane of the fourth horizontally-disposed circular aperture; (iii) having a central height H₄ as measured along said central axis of from about 0.5 up to about 1.0 cm; and (iv) having a volume of from about 0.5 up to about 1.5 cc; and

(c) Removably attached to said hollow body member 110 onto said third vertically disposed cylinder section 21B, a container capping member 10 having a horizontally-disposed liquid -impermeable solid circular planar lid member having a radius R₅ of from about 0.5 up to about 1.5 cm and circumvented by an eighth circular rim having a circumference of 2πR₅; fixedly fused to, an extending downwardly from the entirety of said eighth circular rim, a wall having a height H₅ of from about 2 cm up to about 4 cm, terminating in a fourth cylindrical section having a height H₄′ of from about 0.5 cm up to about 1.0 cm, said fourth cylindrical section having a fourth inner cylindrical surface and a fourth outer cylindrical surface, said fourth inner cylindrical surface being horizontally threaded with a fourth thread having a thread pitch, ρ″′ and a thread depth, Δ″′, said fourth thread mating with, being juxtaposed with, and sealably cooperative with said third thread of said hollow body member.

What is claimed is:

1. A compound hollow container having a multiplicity of compartments, said container having a continuously stable upright configuration and being capable of containing, storing and dispensing one or more readily-utilizable liquids, optionally, fluidized solids and, optionally accessories therefor, said container being equipped with liquid applicators for each of the liquids and, optionally, a fluidized solid dispenser for the fluidized solids, comprising:
(a) A hollow base member means for containing, storing and dispensing a readily-utilizable first liquid, said base member means having an outer liquid-impermeable vertically-disposed surface, a lower horizontally-disposed planar base and an upper horizontally-disposed orifice having an upper orifice rim;
(b) Optional storage member means for containing, storing and dispensing accessories, said storage member means having an outer liquid-impermeable vertically-disposed surface and having an upper section and a lower section, said storage member means being liquid-impermeable, said lower section being detachably and sealably attached to the upper orifice rim of the upper orifice of said base member means;
(c) A hollow body member means for containing, storing and dispensing a second readily utilizable second liquid or a readily utilizable fluidized solid, said body member means having an outer liquid-impermeable and fluidized solid-impermeable vertically-disposed surface and a liquid-impermeable or fluidized solid-impermeable substantially planar horizontally-disposed base and having an upper horizontally-disposed orifice having an upper orifice rim, said body member means being detachably and sealably attached at its base to the upper section of said storage member means or to the upper orifice of said base member means;
(d) Downwardly positioned first applicator means, either (i) externally attached to the base of said body member means or (ii) externally attached to the base of said storage member means, extending downwardly therefrom into the interior of said base member for application of said readily-utilizable first liquid;
(e) Capping means having an vertically-disposed outer liquid-impermeable and fluidized solid-impermeable vertically-disposed surface and an upper horizontally-disposed lid which is either liquid-impermeable, fluidized solid-permeable, fluidized solid-impermeable or fluidized solid-permeabilizable, detachably and sealably attached to the rim of the upper orifice of said body member means;
(f) Optionally attached to either (i) the upper lid of said capping means and extending vertically downwardly therefrom into the interior of said body means or (ii) the upper orifice rim of said body member means and porously covering in its entirety said upper orifice and extending upwardly into the interior of said capping means, second applicator means for application of said readily-utilizable second liquid; further characterized in that (i) when the container is in an upright position and in a closed configuration, the combined vertical outer surface of each of the base member means, the optional storage member means, the body member means and the capping member means form a substantially unitary continuous unbroken outer surface and (ii) the horizontal dimension of the lower horizontally-disposed substantially planar base, DBL is substantially greater than the horizontal dimension of the upper horizontally-disposed lid, DLU.

2. The container of claim 1 wherein each of the attachments is via two mating, juxtaposed screw fittings and/or via two mating snap-fit fittings.

3. A process for utilizing the article of claim 1 comprising the steps of:
(a) Placing a first utilizable fluid into said base member means;
(b) Placing a second utilizable fluid into said body member means;
(c) Constructing said container by attaching said storage means to said base means and to said body means and then attaching said capping means to the upper rim of said body means;
(d) Storing said container containing said utilizable fluids for a finite period of time;
(e) Detaching said storage means or said body member means from said base member means;
(f) Applying said first utilizable fluid to a first surface removed from said article;
(g) Re-attaching said storage means or said body means to said base means;
(h) Detaching said capping means from said body means;
(i) Applying said second utilizable fluid to said first surface removed from said article; and
(j) Re-attaching said capping means to said body means.

4. The container of claim 2 which is a compound hollow bi-compartmentalized container capable of containing, storing and dispensing readily-utilizable liquids and/or readily-utilizable fluidized solids and equipped with liquid applicators for each of the liquids and/or fluidized solid dispensers for each of the fluidized solids, consisting essentially of:
(a) A vertically-disposed hollow base member having a hollow vertically-disposed frusto-conical base section having a planar circular liquid-impermeable first solid base and having a first circular rim; extending upwardly from the entire circumference of said first circular rim a substantially vertically-disposed liquid-impermeable solid thin cylindrical wall surrounding a first volume V₁ terminating at an upper horizontal second circular rim; fixedly fused to the entirety of the said second circular rim and extending upwardly, a vertically-disposed outwardly concave upwardly convergent frusto-hyperbolic section having a thin liquid-impermeable solid wall terminating at an upper horizontal third circular rim fully circumventing a first horizontal aperture; and fixedly fused to said third circular rim a first vertically-disposed cylindrical section having a liquid-impermeable thin solid wall and an inner first cylinder surface and an outer first cylinder surface, said outer first cylinder surface being horizontally threaded with a first thread pitch ρ and a thread depth Δ, said first cylindrical section fully circumventing the entirety of a second horizontally disposed aperture;
(b) Removably attached to said hollow base member onto said first vertically-disposed cylindrical section, a vertically-disposed hollow body member having a hollow vertically-disposed frusto-conical body section having a horizontally-disposed planar circular liquid or fluidized solid-impermeable second solid base having a fourth circular rim circumventing said second solid base; fixedly attached proximate the center of said second solid base, and extending vertically downwardly therefrom into the interior of said frusto-conical base section a first applicator member; fixedly fused to the entirety of said fourth circular rim and extending downwardly, a vertically-disposed outwardly concave downwardly convergent frusto-hyperbolic section having a thin liquid-impermeable wall terminating at a lower horizontal fifth circular rim circumventing a third horizontally-disposed aperture which is co-planar with said second horizontally-disposed aperture; fixedly fused to the entirety of said lower horizontal fifth circular rim, and extending upwardly therefrom, within the confines of said downwardly convergent frusto-hyperbolic section, in a direction perpendicular to the plane of said third horizontally-disposed aperture, a second vertically-disposed cylindrical section having a liquid or fluidized solid-impermeable thin solid wall having an inner second cylinder surface and an outer second cylinder surface, said inner second cylinder surface being horizontally threaded with a second thread having a thread pitch ρ′ and a thread depth Δ′, said second thread mating with and being juxtaposed and removably sealably cooperating with said first thread of said first cylindrical section of said base member (a); extending upwardly from the entirety of said fourth circular rim a substantially vertically-disposed liquid-impermeable solid thin wall surrounding a second volume V₂ terminating at an upper horizontally-disposed sixth circular rim; fixedly fused to the entirety of said sixth circular rim and extending upwardly therefrom in a direction perpendicular to the plane of said third horizontally-disposed aperture, a third vertically-disposed cylindrical section having a liquid or fluidized solid-impermeable thin solid wall having an inner third cylinder surface and an outer third cylinder surface, said outer third cylinder surface being horizontally threaded with a third thread having a thread pitch ρ″ and a thread depth Δ″, said third cylinder wall terminating at a seventh circular rim circumventing a fourth horizontally-disposed aperture; and
(c) Removably attached to said hollow body member onto said third vertically disposed cylinder section, a container capping member having a horizontally-disposed liquid or fluidized solid-impermeable solid circular planar lid member or porous fluidized solid-permeable circular planar base member circumvented by an eighth circular rim; fixedly fused to, and extending downwardly from the entirety of the circumference of said eighth circular rim an outwardly downwardly expanding frusto-conical wall terminating at the inner portion thereof in a fourth cylindrical section having a fourth inner cylindrical surface and a fourth outer cylindrical surface, said fourth inner cylindrical surface being horizontally threaded with a fourth thread having a thread pitch, ρ″′ and a thread depth, Δ″′, said fourth thread mating with, being juxtaposed with, and sealably cooperative with said third thread of said third cylindrical section of said hollow body member; optionally fixedly attached proximate the center of said third solid planar base, and extending vertically downward therefrom into the interior of said frusto-conical body section, in a direction perpendicular to the plane of said third solid planar base, a second applicator; further characterized in that when the container is in an upright position and in a closed configuration, the combined vertical outer surface of each of the base member, the body member and the capping member form a substantially unitary continuous unbroken surface.

5. The container of claim 4 which is a compound hollow bi-compartmentalized container capable of containing, storing and dispensing readily-utilizable liquids and/or readily-utilizable fluidized solids and equipped with liquid applicators for each of the liquids and fluidized solid dispensers for each of the fluidized solids, consisting essentially of:
(a) A vertically-disposed hollow base member having a hollow vertically-disposed frusto-conical base section having a planar circular liquid-impermeable first solid base of radius R₁ of from about 1 cm up to about 2 cm and having a first circular rim having a length of 2πR₁; extending upwardly from the entire circumference of said first circular rim a substantially vertically-disposed liquid-impermeable solid thin cylindrical wall having a height H₁ of from about 2.5 cm up to about 5.0 cm surrounding a first volume V₁ of from about 20 cc up to about 100 cc terminating at an upper horizontal second circular rim having a radius R₂ of from about 1 cm up to about 2 cm; fixedly fused to the entirety of the said second circular rim and extending upwardly therefrom, a vertically-disposed outwardly concave upwardly convergent frusto-hyperbolic section having a height H₂ of from about 0.5 cm up to about 1.5 cm and having a thin liquid-impermeable solid cylindrical wall terminating at an upper horizontal third circular rim fully circumventing a first horizontal aperture having a radius R₃ of from about 0.5 up to about 1.5 cm with the proviso that R₂>R₃; and fixedly fused to said third circular rim a first vertically-disposed cylindrical section having a liquid-impermeable thin solid cylindrical wall and a height H₃ of from about 0.5 cm up to about 1.0 cm and an inner first cylinder surface and an outer first cylinder surface, said outer first cylinder surface being horizontally threaded with a first thread pitch ρ and a thread depth Δ, said first cylindrical section fully circumventing the entirety of a second horizontally disposed aperture of radius R₃;
(b) Removably attached to said hollow base member onto said first vertically-disposed cylindrical section, a vertically-disposed hollow body member having a hollow vertically-disposed frusto-conical body section having a horizontally-disposed planar circular liquid-impermeable or fluidized solid-impermeable second solid base of radius R₂′ of from about 1 cm up to about 2 cm having a fourth circular rim circumventing said second solid base; fixedly attached proximate the center of said second solid base, and extending vertically downwardly therefrom into the interior of said frusto-conical base section a first applicator member having a length L₁ of from about 3.0,cm up to about 6.5 cm with the proviso that H₁≦L₁≦[H₁+H₂+H₃]; fixedly fused to the entirety of said fourth circular rim and extending downwardly, a vertically-disposed outwardly concave downwardly convergent frusto-hyperbolic section having a height H₂′ of from about 0.5 cm up to about 1.5 cm and having a thin liquid-impermeable wall terminating at a lower horizontal fifth circular rim circumventing a third horizontally-disposed aperture of radius R₃′ which is co-planar with said second horizontally-disposed aperture, with the proviso that R₃=R₃′; fixedly fused to the entirety of said lower horizontal fifth circular rim, and extending upwardly therefrom, within the confines of said downwardly convergent frusto-hyperbolic section, in a direction perpendicular to the plane of said third horizontally-disposed aperture, a second vertically-disposed cylindrical section having a liquid or fluidized solid-impermeable thin solid wall of height H₃′ of from about 0.5 cm up to about 1 cm and an inner second cylinder surface and an outer second cylinder surface, said inner second cylinder surface being horizontally threaded with a second thread having a thread pitch ρ′ and a thread depth Δ′, said second thread mating with, being juxtaposed and removably sealably cooperating with said first thread of said first cylindrical section of said base member (a); extending upwardly from the entirety of said fourth circular rim a substantially vertically-disposed liquid-impermeable solid thin wall having a height H₁′ of from about 2.5 cm up to about 5.0 cm surrounding a second volume V₂ of from about 20 cc up to about 100 cc terminating at an upper horizontally-disposed sixth circular rim having a radius R₂′ of from about 1 cm up to about 2 cm; fixedly fused to the entirety of said sixth circular rim and extending upwardly therefrom in a direction perpendicular to the plane of said third horizontally-disposed aperture, a third vertically-disposed cylindrical section having a liquid or fluidized solid-impermeable thin solid wall and a height H₄ of from about 0.5 cm up to about 1.0 cm and an inner third cylinder surface and an outer third cylinder surface, said outer third cylinder surface being horizontally threaded with a third thread having a thread pitch ρ″ and a thread depth Δ″, said third cylinder wall terminating at a seventh circular rim circumventing a fourth horizontally-disposed aperture having a radius R₄ of from about 1 cm up to about 2 cm with the proviso that R₄≦R₃; and
(c) Removably attached to said hollow body member onto said third vertically disposed cylinder section, a container capping member having a horizontally-disposed liquid or fluidized solid-impermeable solid circular planar lid member or porous fluidized solid-permeable circular planar base member having a radius R₅ of from about 0.5 up to about 1.5 cm and circumvented by an eighth circular rim having a circumference of 2πR₅; fixedly fused to, and extending downwardly from the entirety of the circumference of said eighth circular rim, an outwardly, downwardly expanding frusto-conical wall having a height H₅ of from about 2 cm up to about 4 cm, terminating on the inner portion thereof in a fourth cylindrical section having a height H₄′ of from about 0.5 cm up to about 1.0 cm, said fourth cylindrical section having a fourth inner cylindrical surface and a fourth outer cylindrical surface, said fourth inner cylindrical surface being horizontally threaded with a fourth thread having a thread pitch, ρ″′ and a thread depth, Δ″′, said fourth thread mating with, being juxtaposed with, and sealably cooperative with said third thread of said hollow body member; optionally fixedly attached proximate the center of said third solid planar base, and extending vertically downward therefrom into the interior or said frusto-conical body section, in a direction perpendicular to the plane of said third solid planar base, a second applicator member having a length, L₂ of from about 3 cm up to about 8 cm with the proviso that H₁′≦L₂≦[H₁′+H₄+H₅];
further characterized in that when the container is in an upright position and in a closed configuration, the combined vertical outer surface of each of the base member, the body member and the capping member form a substantially unitary continuous unbroken surface.

6. The container of claim 2 which is a compound hollow bi-compartmentalized container capable of containing, storing and dispensing readily-utilizable liquids and equipped with liquid applicators for each of the liquids, consisting essentially of:
(a) A vertically-disposed hollow base member having a hollow vertically-disposed frusto-conical base section having a planar circular liquid-impermeable first solid base of radius R₁ of from about 1 cm up to about 2 cm and having a first circular rim having a length of 2πR₁; extending upwardly from the entire circumference of said first circular rim a substantially vertically-disposed liquid-impermeable solid thin cylindrical wall having a height H₁ of from about 2.5 cm up to about 5.0 cm surrounding a first volume V₁ of from about 20 cc up to about 100 cc terminating at an upper horizontal second circular rim having a radius R₂ of from about 1 cm up to about 2 cm; fixedly fused to the entirety of the said second circular rim and extending upwardly therefrom, a vertically-disposed outwardly concave upwardly convergent frusto-hyperbolic section having a height H₂ of from about 0.5 cm up to about 1.5 cm and having a thin liquid-impermeable solid cylindrical wall terminating at an upper horizontal third circular rim fully circumventing a first horizontal aperture having a radius R₃ of from about 0.5 up to about 1.5 cm with the proviso that R₂>R₃; and fixedly fused to said third circular rim a first vertically-disposed cylindrical section having a liquid-impermeable thin solid cylindrical wall and a height H₃ of from 0.5 cm up to about 1.0 cm and an inner first cylinder surface and an outer first cylinder surface, said outer first cylinder surface being horizontally threaded with a first thread pitch ρ and a thread depth Δ, said first cylindrical section fully circumventing the entirety of a second horizontally disposed aperture of radius R₃;
(b) Removably attached to said hollow base member onto said first vertically-disposed cylindrical section, a vertically-disposed hollow body member having a hollow vertically-disposed frusto-conical body section having a horizontally-disposed planar circular liquid-impermeable second solid base of radius R₂′ of from about 1 cm up to about 2 cm having a fourth circular rim circumventing said second solid base; fixedly attached proximate the center of said second solid base, and extending vertically downwardly therefrom into the interior of said frusto-conical base section a first applicator member having a length L₁ of from about 3.0 cm up to about 6.5 cm with the proviso that H₁≦L₁[H₁+H₂+H₃]; fixedly fused to the entirety of said fourth circular rim and extending downwardly, a vertically-disposed outwardly concave downwardly convergent frusto-hyperbolic section having a height H₂′ of from about 0.5 cm up to about 1.5 cm and having a thin liquid-impermeable wall terminating at a lower horizontal fifth circular rim circumventing a third horizontally-disposed aperture of radius R₃′ which is co-planar with said second horizontally-disposed aperture, with the proviso that R₃=R₃′; fixedly fused to the entirety of said lower horizontal fifth circular rim, and extending upwardly therefrom, within the confines of said downwardly convergent frusto-hyperbolic section, in a direction perpendicular to the plane of said third horizontally-disposed aperture, a second vertically-disposed cylindrical section having a liquid impermeable thin solid wall of height H₃′ of from about 0.5 cm up to about 1 cm and an inner second cylinder surface and an outer second cylinder surface, said inner second cylinder surface being horizontally threaded with a second thread having a thread pitch ρ′ and a thread depth Δ′, said second thread mating with, being juxtaposed and removably sealably cooperating with said first thread of said first cylindrical section of said base member (a); extending upwardly from the entirety of said fourth circular rim a substantially vertically-disposed liquid-impermeable solid thin cylindrical wall having a height H₁′ of from about 2.5 cm up to about 5.0 cm surrounding a second volume V₂ of from about 20 cc up to about 100 cc terminating at an upper horizontally-disposed sixth circular rim having a radius R₂′ of from about 1 cm up to about 2 cm; fixedly fused to the entirety of said sixth circular rim and extending upwardly therefrom in a direction perpendicular to the plane of said third horizontally-disposed aperture, a third vertically-disposed cylindrical section having a liquid-impermeable thin solid wall and a height H₄ of from about 0.5 cm up to about 1.0 cm and an inner third cylinder surface and an outer third cylinder surface, said outer third cylinder surface being horizontally threaded with a third thread having a thread pitch ρ″ and a thread depth Δ″, said third cylinder wall terminating at a seventh circular rim circumscribing a fourth horizontally-disposed aperture having a radius R₄ of from about 1 cm up to about 2 cm with the proviso that R₄≦R₃; removably attached to the entirety of said seventh circular rim and fully covering and fitting within said fourth circular aperture, a microporous or macroporous spheroidal, cylindrical or ellipsoidal or partial spheroidal-covered cylindrical or partial ellisoidal-covered cylindrical-shaped second applicator means (i) having a central circular plane of radius R₄′, where R₄=R₄′, coplanar with said aperture; (ii) having a central substantially vertical axis substantially perpendicular to the plane of the fourth horizontally-disposed circular aperture; (iii) having a central height H₄ as measured along said central axis of from about 0.5 up to about 1.0 cm; and (iv) having a volume of from about 0.5 up to about 1.5 cc; and
(c) Removably attached to said hollow body member onto said third vertically disposed cylinder section, a container capping member having a horizontally-disposed liquid-impermeable solid circular planar lid member having a radius R₅ of from about 0.5 up to about 1.5 cm and circumvented by an eighth circular rim having a circumference of 2πR₅; fixedly fused to, an extending downwardly from the entirety of said eighth circular rim, a wall having a height H₅ of from about 2 cm up to about 4 cm, terminating in a fourth cylindrical section having a height H₄′ of from about 0.5 cm up to about 1.0 cm, said fourth cylindrical section having a fourth inner cylindrical surface and a fourth outer cylindrical surface, said fourth inner cylindrical surface being horizontally threaded with a fourth thread having a thread pitch, ρ″′ and a thread depth, Δ″′, said fourth thread mating with, being juxtaposed with, and sealably cooperative with said third thread of said hollow body member; further characterized in that when the container is in an upright position and in a closed configuration, the combined vertical outer surface of each of the base member, the body member and the capping member form a substantially unitary continuous unbroken surface.

7. The process of claim 3 wherein the first utilizable fluid is nail polish and the second utilizable fluid is nail polish remover.

8. The process of claim 3 wherein the first utilizable fluid is nail polish and the second utilizable fluid is nail polish curing agent.

9. A process for utilizing the article of claim 1 comprising the steps of:
(a) Placing first utilizable fluid in said base member means;
(b) Placing a utilizable fluidized solid in said body member means;
(c) Constructing said container by detachably attaching said storage means to said base means, detachably attaching said body means to said storage means and detachably attaching said capping means having a lid capable of permeabilization to said body means;
(d) Storing said container for an extended period of time;
(e) Detaching said storage means or said body means from said base means;
(f) Applying said first utilizable fluid to a first surface removed from said article;
(g) Re-attaching said storage means or said body means to said base means;
(h) Enabling permeabilization of the upper lid of said capping means to form a fluidized solid-permeable lid; and
(i) Applying said second fluidized solid through said fluidized solid-permeable lid to said first surface removed from said article.

10. The process of claim 9 wherein the lid capable of permeabilization is a circular planar lid having a multiplicity of adjustable orifices therethrough and means for variation of each of the orifice diameters Dₒ from 0 to a maximum diameter Dₘₐₓ wherein 0≦Dₒ≦Dₘₐₓ.

11. The process of claim 10 wherein Dₘₐₓ is 2.0 mm.

12. The process of claim 9 wherein the lid capable of permeabilization is a lid having an orifice covered in its entirety by an adjustable fine mesh screen having an adjustable mesh size M₀ from 0 to a maximum mesh size of M_{∞} where 0≦M₀ ≦M_{∞}.

13. The process of claim 9 wherein said utilizable fluid is nail polish and said fluidized solid is nail glitter.

14. The apparatus of claim 2 also including support means for supporting the container on a mount or wall.

15. The apparatus of claim 14 wherein the support means is attached to the upper rim of the body member means, in the form of a wire loop fixedly and tightly juxtaposed proximate said rim circumference.

16. The apparatus of claim 2 wherein said capping means is detachably attached to said body member means via mating screw fittings.

17. The apparatus of claim 2 wherein said capping means is detachably attached to aid body member means via a mating snap-fit fitting.

18. The apparatus of claim 2 wherein said base member means is detachably attached to said body member means via mating screw fittings.

19. The apparatus of claim 2 wherein said body member means is detachably attached to said storage member means via mating screw fittings.

20. A kit assembly for the construction of a compound hollow container having a multiplicity of compartments, said container having a continuously stable upright configuration when placed on a substantially horizontal planar solid surface, the container being capable of containing, storing and dispensing one or more readily-utilizable liquids, fluidized solids and accessories therefor, said container being equipped with liquid applicators for each of the liquids and a fluidized solid dispenser for the fluidized solids comprising:
(a) A container member means holding palate having a multiplicity of indented three-dimensional holding spaces for fixedly and removably holding container member means;
(b) At least one hollow base member means each of which has an upper circumferential rim and each of which stores one readily-utilizable first liquid, each of which base member means is fixedly and removably contained in an indented three-dimensional holding space of said holding palate;
(c) At least one storage member, each of which stores accessories, said storage member being detachably attachable to each of said base member means, each of said storage members being fixedly and removably contained in an indented three-dimensional holding space of said holding palate;
(d) At least one first hollow body member means each of which has an upper circumferential rim and each of which stores one second readily-utilizable second liquid, each of which body member means being fixedly and removably contained in an indented three-dimensional holding space of said holding palate;
(e) At least one second hollow body member means each of which has an upper circumferential rim and each of which stores one readily-utilizable fluidized solid, each of which body member means being fixedly and removably contained in an indented three-dimensional holding space of said holding palate;
(f) At least two downwardly positionable applicator means, at least one of which is externally attachable to the base of a hollow body member means and at least another of which is externally attachable to the base of a storage member means, each applicator means being capable of extending downwardly from its point of attachment into the interior of the base member for application of said readily-utilizable first liquid, each applicator means being fixedly and removably contained in an indented three-dimensional holding space of said holding palate;
(g) At least two capping member means each of which is fixedly and removably contained in an indented three-dimensional holding space of said holding palate, and each of which capping member means is detachably attachable to the upper rim of a body member means, a first capping member means having an solid impermeable upper lid and a second capping member means having a permeabilizable upper lid for controlling the dispensing of fluidized solids from the body member means to which it is detachably attachable;
(h) At least one elongated brush applicator means removably attachable to the upper lid of each of the first capping member means and being capable of extending downwardly from the upper lid of each of the first capping member means into the interior of each of the body member means, each of said elongated brush applicator means being fixedly and removably contained in an indented three-dimensional holding space of said holding palate; and
(i) At least one porous spherical and/or ellipsoidal pad applicator means removably attachable to each upper orifice rim of each of the body member means and designed to cover the entirety of each upper orifice rim of each body member means, each pad applicator means being capable of extending upwardly into the interior of each of said first capping member means;
further characterized in that when the container is assembled and placed in an upright position and in a closed configuration, (i) the combined vertical outer surface of each of the base member means, the storage member means when present, the body member means and the capping member means form a substantially unitary continuous unbroken outer surface and (ii) the assembled container has the ability to be maintained in a stable upright configuration when placed on a substantially horizontal planar solid surface.

21. A kit for assembly of a compound hollow container having a multiplicity of compartments, said container having a continuously stable upright configuration and being capable of containing, storing and dispensing one or more readily-utilizable liquids, fluidized solids and accessories therefor, said container being equipped with liquid applicators for each of the liquids and a fluidized solid dispenser for the fluidized solids, consisting of:
(a) A container member means holding palate having twenty-one indented three-dimensional holding spaces for fixedly and removably holding container member means;
(b) Three liquid storage containers storing three different readily-utilizable first liquids, said storage containers being removably imbedded, respectively, in a first holding space, a second holding space and a third holding space;
(c) A hollow base member means storing a readily-utilizable first liquid, said base member means imbedded in a fourth holding space, said base member means having an outer liquid-impermeable vertically-disposed surface, a lower horizontally-disposed planar base and an upper horizontally-disposed orifice having an upper orifice rim;
(d) Three accessory storage containers storing three different groups of accessories said storage containers being removably imbedded, respectively, in a fifth holding space, a sixth holding space and a seventh holding space;
(e) A storage member means storing accessories imbedded in an eighth holding space, said storage member means having an outer liquid-impermeable vertically-disposed surface and having an upper section and a lower section, said storage member means being liquid-impermeable, said lower section being detachably and sealably attachable to the upper orifice rim of the upper orifice of said base member means;
(f) Three liquid storage containers storing three different readily-utilizable second liquids, said storage containers being removably imbedded, respectively, in a ninth holding space, a tenth holding space and an eleventh holding space;
(g) Three fluidized solid storage containers storing three different readily-utilizable fluidized solids, said fluidized solid storage containers being removably imbedded, respectively, in a twelfth holding space, a thirteenth holding space and a fourteenth holding space;
(h) A hollow body member means storing a second readily utilizable second liquid removably imbedded in a fifteenth holding space, said body member means having an outer liquid-impermeable vertically-disposed surface and a liquid-impermeable substantially planar horizontally-disposed base and having an upper horizontally-disposed orifice having an upper orifice rim, said body member means being detachably and sealably attachable at its base to the upper section of said storage member means and to the upper orifice of said base member means;
(i) A hollow body member means storing a readily utilizable fluidized solid removably imbedded in a sixteenth holding space, said body member means having an outer fluidized solid-impermeable vertically-disposed surface and fluidized solid-impermeable substantially planar horizontally-disposed base and having an upper horizontally-disposed orifice having an upper orifice rim, said body member means being detachably and sealably attachable at its base to the upper section of said storage member means and to the upper orifice of said base member means;
(j) Downwardly positionable first applicator means removably imbedded in a seventeenth holding space, which has the capability of being either (i) externally attachable to the base of said body member means or (ii) externally attachable to the base of said storage member means, having the capability of extending downwardly therefrom into the interior of said base member for application of any of said readily-utilizable first liquids;
(k) Downwardly positionable second applicator means removably imbedded in a eighteenth holding space, which has the capability of being externally attachable to the underside of the lid of a first capping member means, having the capability of extending downwardly therefrom into the interior of said body member for application of any of said readily-utilizable second liquids;
(l) First capping means removably imbedded in a nineteenth holding space having a vertically-disposed outer liquid-impermeable vertically-disposed surface and an upper horizontally-disposed lid which is liquid-impermeable, said first capping means being detachably and sealably attachable to the rim of the upper orifice of said body member means;
(m) Second capping means removably imbedded in a twentieth holding space having a vertically-disposed outer fluidized solid-impermeable vertically-disposed surface and an upper horizontally-disposed lid which is fluidized solid-permeabilizable, said second capping means being detachably and sealably attachable to the rim of the upper orifice of said body member means; and
(n) Removably imbedded in a twenty-first holding space and attachable to the upper orifice rim of said body member means and capable of porously covering in its entirety said upper orifice and extending upwardly into the interior of said first capping means, second applicator means for application of any of said readily-utilizable second liquids;
further characterized in that when the container is assembled and placed in an upright position and in a closed configuration, (i) the combined vertical outer surface of each of the base member means, the storage member means when present, the body member means and the capping member means form a substantially unitary continuous unbroken outer surface and (ii) since the horizontal dimension of the lower horizontally-disposed substantially planar base, DBL is substantially greater than the horizontal dimension of the upper
horizontally-disposed lid, DLU, the assembled container has the ability to be maintained in a stable upright configuration when placed on a substantially horizontal planar solid surface.

22. The compound hollow container of claim 1 wherein the hollow base member means and hollow body member means each is constructed from a composition selected from the group consisting of glass and polymethyl methacrylate and the optional storage member means and the capping means each is constructed from a composition selected from the group consisting of a cross-linked phenol-formaldehyde resin, a polyacetal resin and a melamine-formaldehyde resin.

23. The process of claim 3 wherein the first utilizable fluid is liquid lip gloss and the second utilizable fluid is liquid lip stick.
